(19) United States
(12) Patent Application Publication
(10) Pub. No.: US 2026/0220791 A1
(43) Pub. Date: Jul. 30, 2026

(54) DATA PROCESSING METHOD AND APPARATUS, DEVICE, MEDIUM, AND PRODUCT

(71) Applicant: BEIJING ZITIAO NETWORK TECHNOLOGY CO., LTD., Beijing (CN)

(72) Inventors: Youjiang XU, Beijing (CN); Bo FAN, Beijing (CN); Jiaqi GU, Beijing (CN); Xin ZHAO, Beijing (CN); Gongyin GUO, Beijing (CN); Wenhao ZHANG, Beijing (CN); Fuwei ZHAO, Beijing (CN); Jiachao LIU, Beijing (CN); Zihao YE, Beijing (CN)

(21) Appl. No.: 19/458,373

(22) Filed: Jan. 23, 2026

(30) Foreign Application Priority Data
Jan. 24, 2025 (CN) 202510122550.9

(51) Int. Cl. G06T 7/20; G06T 7/11; G06V 40/16

(52) U.S. Cl. CPC G06T 7/20; G06T 7/11; G06V 40/174; G06T 2207/20132

(57) ABSTRACT

The present application discloses a data processing method and apparatus, a device, a medium, and a product, where the method includes: first, acquiring a two-dimensional image, so that the two-dimensional image is configured for describing a first part of an object, and acquiring position information of the object in the two-dimensional image; then, cropping a region indicated by the position information from the two-dimensional image to obtain a region image; then, predicting skeleton information according to the region image, so that the skeleton information is configured for describing a second part of the object; then, mapping, by using an objective function, a planar position in the skeleton information to a target region obtained by expanding the region indicated by the position information to obtain a mapped position; and finally, determining motion capture data according to the mapped position and the depth.

### CROSS-REFERENCE TO RELATED APPLICATIONS

This application claims priority to Chinese Patent Application No. 202510122550.9, entitled “DATA PROCESSING METHOD AND APPARATUS, DEVICE, MEDIUM, AND PRODUCT”, and filed on Jan. 24, 2025. The entire disclosure of the prior application is hereby incorporated by reference in its entirety.

### TECHNICAL FIELD

The present application relates to the technical field of data processing, and in particular, to a data processing method and apparatus, a device, a medium, and a product.

### BACKGROUND

Motion capture, which is shorted to mo-cap and also called dynamic capture, is a technology for recording and processing a motion of a certain object (such as a person, animal, or certain substance), so that it can be widely applied in many fields such as entertainment, sports, computer vision, and robotics.

Motion capture technology includes optical mo-cap technology, inertial mo-cap technology, and vision-based mo-cap technology. The vision-based mo-cap technology is used for transforming an image into motion capture data; and the vision-based mo-cap technology can, based on types of acquisition devices of the image, be further divided into mo-cap technology based on a single Red Green Blue (RGB) camera, mo-cap technology based on multi RGB cameras, and mo-cap technology based on a depth camera.

However, the image shot by the single RGB camera does not carry depth information, so that how to analyze the motion capture data from the two-dimensional image has become an urgent technical problem to be solved.

### SUMMARY

In order to solve the above technical problem, the present application provides a data processing method and apparatus, a device, a medium, and a product.

In order to achieve the above objectives, technical solutions provided in the present application are as follows.

The present application provides a data processing method, including: acquiring a two-dimensional image, which is configured for describing a posture of a first part of an object in a two-dimensional space, and acquiring position information of the object in the two-dimensional image; cropping a region indicated by the position information from the two-dimensional image to obtain a region image, and predicting skeleton information according to the region image, where the skeleton information is configured for describing a posture of a second part of the object in a three-dimensional space, an area of the second part being greater than that of the first part, the second part including the first part, and the skeleton information includes a planar position and a depth, the planar position being located within the region indicated by the position information; mapping the planar position to a target region by using an objective function to obtain a mapped position, where the objective function is configured for describing a position correspondence between the target region and the region indicated by the position information, the target region is obtained by expanding the region indicated by the position information according to an expansion coefficient, and the objective function is determined according to the expansion coefficient; and determining motion capture data corresponding to the two-dimensional image according to the mapped position and the depth.

In a possible implementation, the skeleton information is obtained by processing the region image by a skeleton detection model; and the method further includes: determining label information corresponding to the two-dimensional image according to a body part of the object located within the target region, where the label information is configured for describing an actual posture of the body part in the three-dimensional space, the body part is part or all of the second part, an area of the body part is greater than that of the first part, and the body part includes the first part; and updating the skeleton detection model according to a difference between the motion capture data and the label information.

In a possible implementation, the motion capture data is configured for describing a predicted posture of the second part under a target skeleton; and acquiring the label information includes: acquiring a three-dimensional mesh corresponding to the two-dimensional image, where the three-dimensional mesh is configured for describing an actual posture of a whole body of the object in the three-dimensional space; and determining the label information according to skeleton information of the three-dimensional mesh under the target skeleton and the body part of the object located within the target region, where the label information is configured for indicating an actual posture of the body part under the target skeleton.

In a possible implementation, after the predicting the skeleton information according to the region image, the method further includes: updating, in response to that the skeleton information represents that the first part does not fall completely within the region indicated by the position information, the position information according to a relative position relationship between a part in the first part that falls outside the region indicated by the position information and a part in the first part that falls within the region indicated by the position information, so that a part in the first part that falls within the region indicated by the position information after the updating is more than a part in the first part that falls within the region indicated by the position information before the updating, and continuing performing the step of predicting the skeleton information according to the region image.

In a possible implementation, the method further includes: analyzing the relative position relationship from a reference image corresponding to the two-dimensional image, where the two-dimensional image and the reference image belong to a same video, an arrangement position of the reference image in the video is prior to that of the two-dimensional image in the video, and the reference image includes the first part.

In a possible implementation, the acquiring the position information of the object in the two-dimensional image includes: determining the position information of the object in the two-dimensional image according to position information of the object in a previous frame of image corresponding to the two-dimensional image, where the two-dimensional image and the previous frame of image both belong to a same video, an arrangement position of the previous frame of image in the video is prior to that of the two-dimensional image in the video, and the arrangement position of the previous frame of image in the video is adjacent to that of the two-dimensional image in the video.

In a possible implementation, the method further includes: determining expression information from the two-dimensional image, where the expression information is configured for describing an expression of a face of the object, the face including a plurality of partitions, and analyzing an occlusion area of each of the partitions from the two-dimensional image; updating, for any of the partitions, the expression information according to preset information corresponding to the partition in response to that the occlusion area of the partition reaches a preset threshold, so that the updated expression information includes the preset information, where the preset information is configured for describing a state of the partition under a preset expression; and the determining the motion capture data corresponding to the two-dimensional image according to the mapped position and the depth including: determining the motion capture data corresponding to the two-dimensional image according to the expression information, the mapped position, and the depth.

In a possible implementation, the occlusion area of each of the partitions is obtained by processing the two-dimensional image by a pre-trained occlusion detection model, where the occlusion detection model is trained by using a sample image and label information corresponding to the sample image, at least one face occlusion region existing in the sample image, and the label information corresponding to the sample image being configured for indicating an area of each of the face occlusion region.

In a possible implementation, the method further includes: determining, in response to failure to detect the face of the object from the two-dimensional image, a head rotation corresponding to the two-dimensional image according to a head rotation predicted from a preceding image corresponding to the two-dimensional image, where the two-dimensional image and the preceding image belong to a same video, and an arrangement position of the preceding image in the video is prior to that of the two-dimensional image in the video; and the determining the motion capture data corresponding to the two-dimensional image according to the mapped position and the depth including: determining the motion capture data corresponding to the two-dimensional image according to the head rotation corresponding to the two-dimensional image, the mapped position, and the depth.

In a possible implementation, the method further includes: determining, according to at least one type of data determined from the two-dimensional image, whether the face of the object is detected from the two-dimensional image, where different data in the at least one type of data is configured for describing different features of the face, and the at least one type of data includes part or all of a face probability, a face segmentation region, a head rotation, and a face identifier, the face probability being configured for indicating a probability that the face exists in the two-dimensional image, the face segmentation region being configured for indicating a position of the face in the two-dimensional image, the head rotation being configured for indicating an orientation of the face in the two-dimensional image, and the face identifier being configured for indicating facial features of the face in the two-dimensional image.

In a possible implementation, the determining, according to the at least one type of data determined from the two-dimensional image, whether the face of the object is detected from the two-dimensional image includes: determining failure to detect the face of the object from the two-dimensional image in response to that the face probability does not exceed a preset probability threshold, an area of the face segmentation region does not exceed a preset area threshold, the head rotation determined from the two-dimensional image does not meet a preset head rotation constraint, or the face identifier determined from the two-dimensional image is inconsistent with a face identifier determined from the preceding image; and determining that the face of the object is detected from the two-dimensional image in response to that the face probability exceeds the preset probability threshold, the area of the face segmentation region exceeds the preset area threshold, the head rotation determined from the two-dimensional image meets the preset head rotation constraint, and the face identifier determined from the two-dimensional image is consistent with the face identifier determined from the preceding image.

In a possible implementation, the method further includes part or all of: determining whether a face probability determined from the two-dimensional image exceeds a preset probability threshold, where the face probability is configured for indicating a probability that the face exists in the two-dimensional image; determining failure to detect the face of the object from the two-dimensional image in response to that the face probability does not exceed the preset probability threshold; determining whether an area of a face segmentation region determined from the two-dimensional image exceeds a preset area threshold in response to that the face probability exceeds the preset probability threshold, where the face segmentation region is configured for indicating a position of the face in the two-dimensional image; determining failure to detect the face of the object from the two-dimensional image in response to that the area of the face segmentation region does not exceed the preset area threshold; determining whether a head rotation predicted from the two-dimensional image meets a preset head rotation constraint in response to that the area of the face segmentation region exceeds the preset area threshold, where the predicted head rotation is configured for indicating an orientation of the face in the two-dimensional image; determining failure to detect the face of the object from the two-dimensional image in response to that the predicted head rotation does not meet the preset head rotation constraint; determining whether a face identifier determined from the two-dimensional image is consistent with a face identifier determined from the preceding image in response to that the predicted head rotation meets the preset head rotation constraint, where the face identifier is configured for describing facial features of the face; determining failure to detect the face of the object from the two-dimensional image in response to that the face identifier determined from the two-dimensional image is inconsistent with the face identifier determined from the preceding image; and determining that the face of the object is detected from the two-dimensional image in response to that the face identifier determined from the two-dimensional image is consistent with the face identifier determined from the preceding image.

In a possible implementation, the two-dimensional image, a plurality of first images having consecutive arrangement positions, and a second image all belong to a same video, an arrangement position of the second image in the video is prior to that of each of the first images in the video, the arrangement position of each of the first images in the video is prior to that of the two-dimensional image in the video, with failure to detect the face of the object from each of the first images, a head rotation corresponding to each of the first images reuses a head rotation predicted from the second image; and the method further includes: performing, in response to detecting the face of the object from the two-dimensional image, interpolation processing according to the head rotation predicted from the second image and a head rotation predicted from the two-dimensional image, to obtain an interpolation processing result, where the interpolation processing result includes a plurality of head rotations arranged in sequence, each of the plurality of head rotations being between the head rotation predicted from the second image and the head rotation predicted from the two-dimensional image; and determining a head rotation corresponding to the two-dimensional image and a head rotation corresponding to at least one third image respectively according to the interpolation processing result, and determining the head rotation predicted from the two-dimensional image as a head rotation corresponding to a fourth image, where the arrangement position of the two-dimensional image in the video is prior to that of each of the third image in the video, and the arrangement position of each of the third image in the video is prior to that of the fourth image in the video, where for any of the images in the video, motion capture data corresponding to the image is determined according to a head rotation corresponding to the image.

In a possible implementation, the first part is an upper body and the second part is the whole body.

The present application provides a data processing apparatus, including: a data acquiring unit configured to acquire a two-dimensional image for describing a posture of a first part of an object in a two-dimensional space, and acquire position information of the object in the two-dimensional image; a first processing unit configured to crop a region indicated by the position information from the two-dimensional image to obtain a region image, and predict skeleton information from the region image, where the skeleton information is configured for describing a posture of a second part of the object in a three-dimensional space, an area of the second part being greater than that of the first part, and the second part including the first part, and the skeleton information includes a planar position and a depth, the planar position being located within the region indicated by the position information; a position mapping unit configured to map the planar position to a target region by using an objective function to obtain a mapped position, where the objective function is configured for describing a position correspondence between the target region and the region indicated by the position information, the target region is obtained by expanding the region indicated by the position information according to an expansion coefficient, and the objective function is determined according to the expansion coefficient; and a first determining unit configured to determine motion capture data corresponding to the two-dimensional image according to the mapped position and the depth.

The present application provides an electronic device, including: a processor and a memory, where the memory is configured to store instructions or a computer program; and the processor is configured to execute the instructions or computer program in the memory to cause the electronic device to perform the data processing method according to the present application.

The present application provides a computer-readable medium having therein stored instructions or a computer program which, when run on a device, causes the device to perform the data processing method according to the present application.

The present application provides a computer program product including a computer program carried on a non-transitory computer-readable medium, the computer program including program code for performing the data processing method according to the present application.

### BRIEF DESCRIPTION OF THE DRAWINGS

In order to more clearly illustrate the technical solutions in the embodiments of the present application or the related art, the drawings that need to be used in the description of the embodiments or the related art will be briefly introduced below, and it is obvious that the drawings in the description below are only some embodiments described in the present application, and for one of ordinary skill in the art, other drawings can also be obtained according to the drawings without paying creative labor.

FIG. 1 is a flow diagram of a data processing method according to an embodiment of the present application;

FIG. 2 is a schematic diagram of a determination process of skeleton information according to an embodiment of the present application;

FIG. 3 is a schematic diagram of a training process of a skeleton detection model according to an embodiment of the present application;

FIG. 4 is a schematic diagram of a target skeleton according to an embodiment of the present application;

FIG. 5 is a schematic diagram of an updating process of position information according to an embodiment of the present application;

FIG. 6 is a schematic structural diagram of a data processing apparatus according to an embodiment of the present application;

FIG. 7 is a schematic structural diagram of an electronic device according to an embodiment of the present application.

### DETAILED DESCRIPTION

Through research, it has been found that, for mo-cap technology based on a single RGB camera, if the camera is used for shooting part of a body (e.g., an upper body) of one object, this makes only the part of the body occur in a shot image, and thus, when motion capture data is determined from the image, there are not only a need to search, from the image, a position of each skeleton point in the part of the body, but also a need to search, from the image, a position of each skeleton point in a body part (e.g., a lower body) not in-picture, which will forcibly map the out-picture body part to the inside of the image, resulting in the inaccurate motion capture data, and thus resulting in easy occurrence of jitters.

Based on the above research, in order to better overcome the above problem, the present application provides a data processing method, including: first, acquiring a two-dimensional image, so that the two-dimensional image is used for describing a posture of a first part (e.g., an upper body) of an object in a two-dimensional space, and acquiring position information (such as a body detection box) of the object in the two-dimensional image; then cropping a region indicated by the position information from the two-dimensional image to obtain a region image, so that the region image can better describe the posture of the first part with as little background interference as possible; then, predicting skeleton information according to the region image, so that the skeleton information is used for describing a posture of a second part (e.g., a whole body) of the object in a three-dimensional space, the skeleton information including a planar position and a depth, and the planar position being located within the region indicated by the position information, and thus the skeleton information can describe a position of each skeleton point in the second part within the region indicated by the position information; then, mapping, by using an objective function, the planar position to a target region obtained by expanding the region indicated by the position information to obtain a mapped position, so that the mapped position can describe a position of each skeleton point in the second part within the target region; and finally, determining motion capture data corresponding to the two-dimensional image according to the mapped position and the depth, so that the motion capture data can not only describe a state of a body part (e.g., an upper body) occurring in the two-dimensional image, but also describe a state of a body part (e.g., a lower body) not occurring in the two-dimensional image, thereby enabling the effect of predicting the in-picture and out-picture body parts, and then enabling defects (e.g., defects such as jitters caused by failure to predict the out-picture body part) caused by occurrence of only part of the body in the two-dimensional image to be effectively overcome, which helps to improve the determination effect of the motion capture data.

In addition, the target region is obtained by expanding the region indicated by the position information according to the expansion coefficient, and the objective function is determined according to the expansion coefficient, so that the objective function can describe a position correspondence between the target region and the region indicated by the position information, and thus the skeleton information can be transformed from the region indicated by the position information to the target region based on the objective function, to describe an object's body using as large a region as possible, and then defects caused by forcibly mapping the out-picture body part to the in-picture due to the fact that the region indicated by the position information is too small can be effectively overcome, which helps to improve the accuracy of the motion capture data.

Furthermore, the present application does not limit an execution subject of the data processing method, for example, the method may be applied to a terminal device or server. For another example, the method may also be implemented by means of data interaction between the terminal device and the server. The terminal device may be a smartphone, computer, personal digital assistant (PDA), tablet computer, or the like. The server may be a stand-alone server, cluster server, or cloud server.

In order to make those skilled in the art better understand the solutions of the present application, the technical solutions in the embodiments of the present application will be clearly and completely described below with reference to the drawings in the embodiments of the present application, and it is obvious that the described embodiments are only part of the embodiments of the present application, but not all of the embodiments. All other embodiments, which can be obtained by one of ordinary skill in the art without making creative labor based on the embodiments in the present application, are within the scope of protection of the present application.

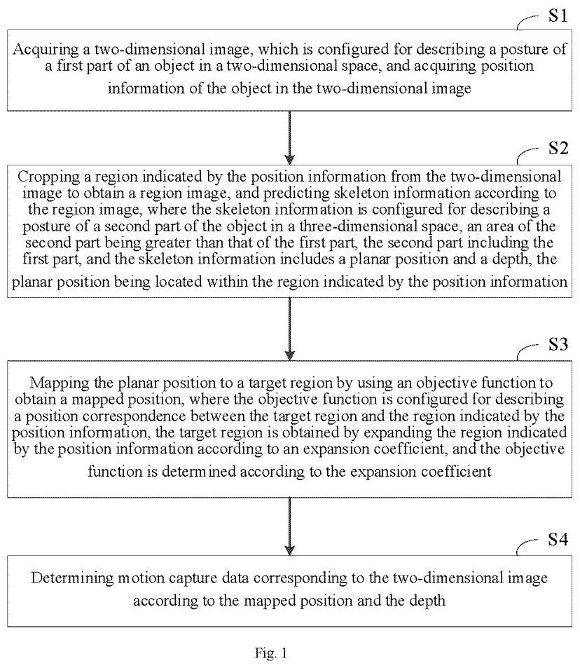

In order to better understand the technical solutions provided in the present application, the data processing method provided in the present application will be first described below with reference to some drawings. As shown in FIG. 1, a data processing method provided in an embodiment of the present application includes S1-S4 hereinafter.
S1: acquiring a two-dimensional image, which is configured for describing a posture of a first part of an object in a two-dimensional space, and acquiring position information of the object in the two-dimensional image.

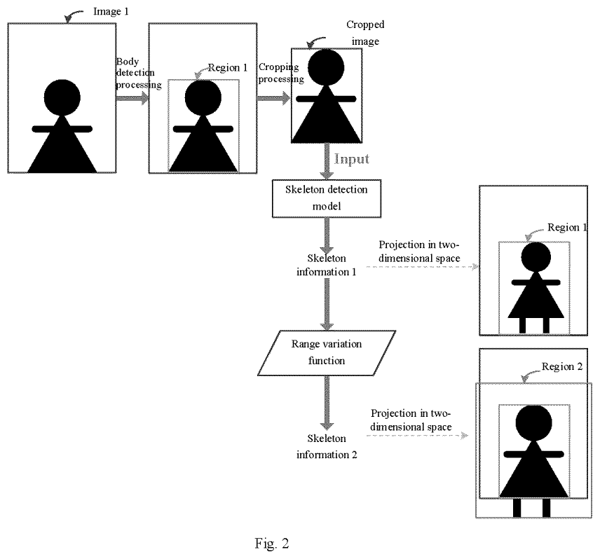

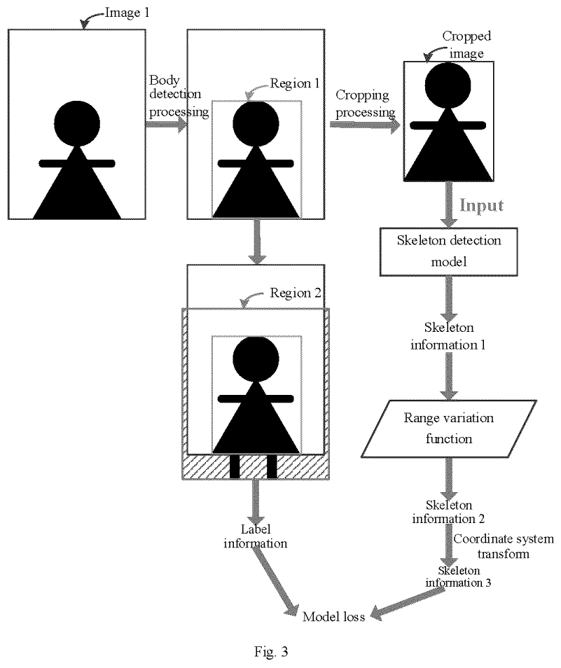

The two-dimensional image is used for describing a posture of a first part of an object in a two-dimensional space. The first part refers to a body part existing in the object and presented by the two-dimensional image, e.g., an upper body presented by image 1 in FIG. 2 or 3. It can be seen that the first part refers to part of a body of the object.

In addition, the present application does not limit the acquisition of the two-dimensional image, for example, the two-dimensional image may be an upper body image (e.g., image 1 shown in FIG. 2 or 3) shot by a monocular camera for an object, so that the two-dimensional image is used for describing a posture of an upper body of the object in the two-dimensional space. It can be seen that in a possible implementation, the first part is an upper body.

Furthermore, the present application does not limit the implementation of the object, for example, it may be implemented by using a person, animal, or avatar.

Moreover, for an object described by a two-dimensional image, position information of the object in the two-dimensional image is used for describing a position (e.g., region 1 shown in FIG. 2 or 3) of the object in the two-dimensional image; and the present application do not limit the implementation of the position information, for example, it may be implemented by using any representation (e.g., a coordinate of a left vertex of a detection box and a width of the detection box and a height of the detection box) of a detection box (e.g., a inner box as shown in FIG. 2 or 3).

It can be seen that, in a possible implementation, the position information of the object in the two-dimensional image may include a coordinate of a target point (e.g., a left vertex or a center point) in a detection box, a width of the detection box, and a height of the detection box, so that the position information can represent a position of the detection box (also called a bounding box or body box) of the object in the two-dimensional image.

Furthermore, the present application does not limit the acquisition of the “position information of the object in the two-dimensional image”, for example, in some scenarios, such as a live scenario with a relatively high requirement for a tracking effect, the position information of the object in the two-dimensional image may be obtained by performing body detection processing on the two-dimensional image, so that the position information can relatively accurately represent the position of the object in the two-dimensional image. It should be noted that the present application does not limit the implementation of the body detection processing, for example, it may be implemented by using any method by which a position of an object can be detected from an image, such as by means of a pre-constructed machine learning model with a body detection function.

For another example, in some scenarios, such as live scenarios where there is a high real-time requirement when an image acquired in real time is transformed into motion capture data, determining the “position information of the object in the two-dimensional image” may be: determining the position information of the object in the two-dimensional image according to position information of the object in a previous frame of image corresponding to the two-dimensional image, to achieve the efficient tracking effect. The “position information of the object in a previous frame of image corresponding to the two-dimensional image” is used for describing a position of the object in the previous frame of image.

It should be noted that, at least the following constraint is met between the two-dimensional image and the previous frame of image corresponding to the two-dimensional image: the two-dimensional image and the previous frame of image both belonging to a same video, an arrangement position of the previous frame of image in the video being prior to that of the two-dimensional image in the video, and the arrangement position of the previous frame of image in the video being adjacent to that of the two-dimensional image in the video.

It should also be noted that the present application does not limit the implementation of the step “determining the position information of the object in the two-dimensional image according to position information of the object in a previous frame of image corresponding to the two-dimensional image”, for example, it may be implemented by determination of a tracking box between two adjacent image frames in any tracking solution. For another example, in some scenarios, such as a live scenario where the object rarely moves greatly, position information of the object in a previous frame of image corresponding to the two-dimensional image may be determined as the position information of the object in the two-dimensional image.

Based on the related content of the S1, it can be seen that in some scenarios, such as live scenarios where an image acquired in real time is transformed into motion capture data, a two-dimensional image shot by a monocular camera for the object and position information of the object in the two-dimensional image are acquired, to subsequently enable the two-dimensional image to be transformed into motion capture data based on the two pieces of data.
S2: cropping a region indicated by the position information from the two-dimensional image to obtain a region image, and predicting skeleton information according to the region image, where the skeleton information is configured for describing a posture of a second part of the object in a three-dimensional space, an area of the second part being greater than that of the first part, the second part including the first part, and the skeleton information includes a planar position and a depth, the planar position being located within the region indicated by the position information.

The region image refers to an image part (e.g., cropped image shown in FIG. 2 or 3) cropped from the two-dimensional image and located within the region indicated by the position information, so that the region image can better describe a body part (e.g., an upper body) enclosed by the region indicated by the position information in the two-dimensional image.

The skeleton information refers to a result (e.g., skeleton information 1 shown in FIG. 2 or 3) obtained by performing skeleton prediction processing on the region image, so that the skeleton information is used for describing the posture of the second part of the object in the image in the three-dimensional space. The second part refers to a body part (e.g., a whole body) which exists in the object and can be described by the skeleton information, an area of the second part being greater than that of the first part, and the second part including the first part.

It should be noted that the present application does not limit the implementation of the second part, for example, the second part may be implemented by using the whole body.

It should also be noted that the present application does not limit the implementation of the skeleton prediction processing, for example, it may be implemented by using a machine learning model (e.g., a skeleton point detection model) with a skeleton prediction function.

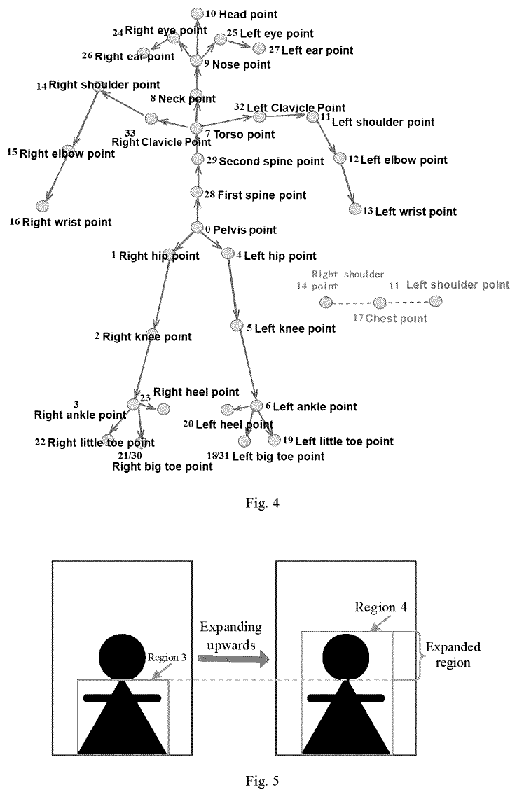

In addition, the present application does not limit the implementation of the skeleton information, for example, the skeleton information may be used for describing a predicted posture (e.g., a predicted state of each skeleton point) of the second part under a target skeleton. It can be seen that, when the second part is the whole body, the skeleton information may include predicted information of each skeleton point in the target skeleton, so that the skeleton information can not only describe a predicted state of a skeleton point (e.g. an in-picture skeleton point) actually existing in the region image in the three-dimensional space, but also describe a predicted state of a skeleton point (e.g. an out-picture skeleton point) not occurring in the region image in the three-dimensional space. The target skeleton is a pre-designed three-dimensional skeleton (e.g., a three-dimensional skeleton shown in FIG. 4). Prediction information of a jth skeleton point refers to information (e.g., a UV coordinate and depth) obtained by performing skeleton prediction processing on the region image and used for describing a state of the jth skeleton point in the target skeleton in the three-dimensional space, where j is a positive integer, and j≤the total number (e.g., 32 shown in FIG. 4) of the skeleton points.

Furthermore, the present application does not limit the implementation of the prediction information of the jth skeleton point, for example, it may include a planar position (e.g., a UV coordinate) of the jth skeleton point and a depth (Depth) of the jth skeleton point. It can be seen that, in a possible implementation, the prediction information of the jth skeleton point is used for describing a state of the jth skeleton point in a first three-dimensional coordinate system (e.g., a UV+Depth coordinate system). It should be noted that, the present application does not limit the implementation of the planar position, for example, it may be implemented by using a UV coordinate.

Moreover, for any skeleton point in the target skeleton, prediction information of the skeleton point is determined according to the region image (e.g., cropped image shown in FIG. 2 or 3), so that the prediction information of the skeleton point is determined by searching a pixel point matched with the skeleton point from the region image, and thus a planar position in the prediction information of the skeleton point is within the region image, and then the planar position is within the region (e.g., region 1 shown in FIG. 2 or 3) indicated by the position information, which makes both the in-picture skeleton point and the out-picture skeleton point aggregate within the region image, and thus makes the prediction information of the skeleton points unable to accurately describe the body posture of the object.
S3: mapping the planar position to a target region by using an objective function to obtain a mapped position, where the objective function is configured for describing a position correspondence between the target region and the region indicated by the position information, the target region is obtained by expanding the region indicated by the position information according to an expansion coefficient, and the objective function is determined according to the expansion coefficient.

The target region (e.g. region 2 shown in FIG. 2 or 3) is obtained by expanding the region (e.g. region 1 shown in FIG. 2 or 3) indicated by the position information according to a preset expansion coefficient, so that the target region not only includes the region indicated by the position information, but also includes an added region obtained through the expansion, and thus an area of the target region is greater than that of the region indicated by the position information, and then the target region can not only include the in-picture region but also include the out-picture region, which makes the target region not only enclose the in-picture body part but also enclose the out-picture body part, and thus enables the target region to accommodate the body of the object as much as possible, and then enables the skeleton information (e.g., skeleton information 2 shown in FIG. 2 or 3) determined by using the target region to not only describe the state of the in-picture skeleton point, but also describe the state of the out-picture skeleton point.

It should be noted that the present application does not limit the implementation of the expansion coefficient, for example, when the two-dimensional image is an upper body image, the expansion coefficient of 25% may be implemented, so that a target region obtained according to the expansion coefficient is a region obtained by expanding both left and right boundaries of the region indicated by the position information outward by 25% of the width of the “region indicated by the position information” and expanding both upper and lower boundaries of the region indicated by the position information outward by 25% of the height of the “region indicated by the position information”, so that an area of the target region is 1.5×1.5 times the area of the region indicated by the position information. As another example, the expansion coefficient may be determined according to an actual application scenario.

The objective function is determined according to the expansion coefficient, so that the objective function can describe the position correspondence between the target region and the region indicated by the position information, and thus the skeleton information can be subsequently transformed from the region indicated by the position information to the target region by using the objective function, to achieve the range change effect.

In addition, the present application does not limit the objective function, for example, it may be implemented by using a function shown in formula (1) hereinafter.

$$f ( x ) = x \times α - β \qquad ( 1 )$$

where x represents a position in the region indicated by the position information; α represents a magnification factor, e.g., 2; β is an average, e.g., 1; and f(x) is a result obtained by transforming x from the region indicated by the position information to the target region, e.g., a mapped position. The two parameters α and β both are determined according to the expansion coefficient, so that the range change function shown in the formula (1) can transform any position in the region indicated by the position information to a corresponding position within the target region.

Based on the related content of the S3 hereinbefore, it can be seen that, after the skeleton information is predicted according to the region image, if the skeleton information includes planar positions (e.g., UV coordinates) of a plurality of skeleton points, the planar positions of skeleton points are respectively input into the objective function, so that the objective function can map the planar positions to the target region, to obtain mapped positions of the skeleton points, and thus the mapped positions of the skeleton points can represent positions of the skeleton points in the target region.

S4: determining motion capture data corresponding to the two-dimensional image according to the mapped position and the depth.

It should be noted that the present application does not limit the implementation of the S4, for example, it may specifically be: first, transforming a mapped position of the jth skeleton point and the depth of the jth skeleton point from the first three-dimensional coordinate system into a second three-dimensional coordinate system (e.g., an XYZ coordinate system) to obtain a three-dimensional position (e.g., an XYZ coordinates) of the jth skeleton point, where j is a positive integer and j≤the total number of the skeleton points; and then, determining motion capture data corresponding to the two-dimensional image according to the three-dimensional positions of all the skeleton points, so that the motion capture data includes the three-dimensional positions of the skeleton points.

For another example, if the skeleton information hereinbefore further includes rotation information (e.g., rotation information of each skeleton point), the S4 hereinbefore may be: determining motion capture data corresponding to the two-dimensional image according to the mapped position, the depth, and the rotation information.

Based on the related content of the S1 to S4, it can be seen that a determination solution for motion capture data provided in the present application includes: first, acquiring a two-dimensional image, so that the two-dimensional image is used for describing a posture of a first part (e.g., an upper body) of an object in a two-dimensional space, and acquiring position information (such as a body detection box) of the object in the two-dimensional image; then cropping a region indicated by the position information from the two-dimensional image to obtain a region image, so that the region image can better describe the posture of the first part with as little background interference as possible; then, predicting skeleton information according to the region image, so that the skeleton information is used for describing a posture of a second part (e.g., a whole body) of the object in a three-dimensional space, the skeleton information including a planar position and a depth, and the planar position being located within the region indicated by the position information, and thus the skeleton information can describe a position of each skeleton point in the second part within the region indicated by the position information; then, mapping, by using an objective function, the planar position to a target region obtained by expanding the region indicated by the position information to obtain a mapped position, so that the mapped position can describe a position of each skeleton point in the second part within the target region; and finally, determining motion capture data corresponding to the two-dimensional image according to the mapped position and the depth, so that the motion capture data can not only describe a state of a body part (e.g., an upper body) occurring in the two-dimensional image, but also describe a state of a body part (e.g., a lower body) not occurring in the two-dimensional image, thereby enabling the effect of predicting the in-picture and out-picture body parts, and then enabling defects (e.g., defects such as jitters caused by failure to predict the out-picture body part) caused by occurrence of only part of the body in the two-dimensional image to be effectively overcome, which helps to improve the determination effect of the motion capture data.

In addition, the target region is obtained by expanding the region indicated by the position information according to the expansion coefficient, and the objective function is determined according to the expansion coefficient, so that the objective function can describe a position correspondence between the target region and the region indicated by the position information, and thus the skeleton information can be transformed from the region indicated by the position information to the target region based on the objective function, to describe an object's body using as large a region as possible, and then defects caused by forcibly mapping the out-picture body part to the in-picture due to the fact that the region indicated by the position information is too small can be effectively overcome, which helps to improve the accuracy of the motion capture data.

Furthermore, in order to better improve the accuracy, the skeleton information may be obtained by processing the region image by a skeleton detection model (e.g., a skeleton detection model shown in FIG. 2 or 3), so that the skeleton information is output data of the skeleton detection model. The skeleton detection model is used for predicting prediction information (e.g., UV coordinate+depth+rotation information) of each skeleton point in the target skeleton according to the region image.

In addition, in order to better improve the accuracy, the present application further provides a training method for the skeleton detection model, which specifically includes part or all of steps 11-16 hereinafter.
Step 11: acquiring a two-dimensional image, which is configured for describing a posture of a first part of an object in a two-dimensional space, and acquiring position information of the object in the two-dimensional image are.

It should be noted that for the related content of step 11, please refer to the related content in the S1 hereinbefore.

It should also be noted that the present application does not limit the acquisition of the two-dimensional image in step 11, for example, it may be: first, randomly selecting a video from a training database as a sample video; and then, randomly selecting, from the sample video, a frame of image as the two-dimensional image.
Step 12: cropping a region indicated by the position information from the two-dimensional image to obtain a region image, and processing the region image by using a skeleton detection model to obtain skeleton information, where the skeleton information is configured for describing a posture of a second part of the object in a three-dimensional space, an area of the second part being greater than that of the first part, and the second part including the first part, and the skeleton information includes a planar position and a depth, the planar position being located within the region indicated by the position information.

It should be noted that for the related content of step 12, please refer to the related content of the S2 hereinbefore.
Step 13: mapping the planar position to a target region by using an objective function to obtain a mapped position, where the objective function is configured for describing a position correspondence between the target region and the region indicated by the position information, the target region is obtained by expanding the region indicated by the position information according to an expansion coefficient, and the objective function is determined according to the expansion coefficient.

It should be noted that for the related content of step 13, please refer to the related content of the S3 hereinbefore.
Step 14: determining motion capture data corresponding to the two-dimensional image according to the mapped position and the depth.

It should be noted that for the related content of step 14, please refer to the related content of the S4 hereinbefore.
Step 15: determining label information corresponding to the two-dimensional image according to a body part (e.g., a whole body) of the object located within the target region, where the label information is configured for describing an actual posture of the body part in the three-dimensional space, the body part is part or all of the second part, an area of the body part is greater than that of the first part, and the body part includes the first part.

The body part of the object located within the target region refers to a body part of the object falling within the target region, such as a body part enclosed by region 2 in FIG. 3.

In addition, the target region is obtained by expanding the region indicated by the position information, so that the target region not only includes the region indicated by the position information, but also includes an added region obtained through the expansion, and thus the “body part of the object located within the target region” not only includes the body part (e.g., an upper body) in the two-dimensional image that is enclosed by the region indicated by the position information, but also includes the body part (e.g., a lower body) of the object that does not occur in the two-dimensional image, and then the “body part of the object located within the target region” can describe the object as completely as possible.

It can be seen that, in a possible implementation, the “body part of the object located within the target region” may meet at least the following constraints: the body part being part or all of the second part, an area of the body part being greater than that of the first part, and the body part including the first part.

Furthermore, the present application does not limit the determination of the “body part of the object located within the target region”, for example, when the two-dimensional image belongs to a certain video, the “body part of the object located within the target region” may be determined according to the two-dimensional image and at least one frame of image with a forward arrangement position corresponding to the two-dimensional image in the video. The “at least one frame of image with a forward arrangement position” refers to an image which exists in the video and of which an arrangement position is prior to that of the two-dimensional image; and the “at least one frame of image with a forward arrangement position” can completely describe features (such as a size and shape) of each body part of the object.

The label information corresponding to the two-dimensional image is used for describing the actual posture of the “body part of the object located within the target region” in the three-dimensional space, so that the training process of the skeleton detection model can be guided by taking the label information as a ground truth subsequently. The “body part of the object located within the target region” not only includes the in-picture body part, but also includes the out-picture body part, so that the skeleton detection model trained based on the “body part of the object located within the target region” can more accurately predict the in-picture skeleton point and the out-picture skeleton point, thereby making the motion capture data determined based on the trained skeleton detection model better.

In addition, the present application does not limit the acquisition of the label information corresponding to the two-dimensional image, for example, it may be implemented by using manual annotation or human-computer interaction.

It should be noted that the present application does not limit an execution time of step 15, with the only requirement that the execution time of step 15 is earlier than that of step 16 hereinafter.
Step 16: updating the skeleton detection model according to a difference between the motion capture data corresponding to the two-dimensional image and the label information corresponding to the two-dimensional image, and returning to continue executing step 11 and its subsequent steps, where such an iterative loop is performed, until a preset stop condition (for example, a model loss of the skeleton detection model being less than a preset loss threshold, a change rate of the model loss being less than a preset change rate threshold, or the number of updates of the skeleton detection model reaching a preset number threshold) is reached, where at least one round of iterative update for the skeleton detection model is ended.

The model loss of the skeleton detection model is used for describing a performance of the skeleton detection model; and the model loss is determined according to a difference between the motion capture data (e.g., an XYZ coordinates) corresponding to the two-dimensional image and the label information corresponding to the two-dimensional image.

Based on the related content of steps 11 to 16 hereinbefore, it can be seen that the skeleton detection model can learn how to predict the in-picture skeleton point and the out-picture skeleton point from some images and their corresponding label information by at least one round of training process, so that the trained skeleton detection model can not only perceive the position of the skeleton point occurring in one image, but also perceive the position of the skeleton point not occurring in the image, to expand a perceptual range of the skeleton detection model, thereby making the motion capture data acquired based on the skeleton detection model better.

Through research, it has been found that for some databases, the databases can not only provide the two-dimensional image, but also provide a three-dimensional mesh corresponding to the two-dimensional image, so that the three-dimensional mesh can accurately represent the actual posture of the object in the two-dimensional image.

Through research, it has also been found that the three-dimensional meshes themselves in the databases are annotated with skeletons, but the skeletons annotated in the different three-dimensional meshes themselves may belong to different types of skeletons, so that a certain difference exists between the skeletons and a target skeleton used by the skeleton detection model, thereby making a skeleton detection model trained by directly using the skeletons as guidance information present a poor performance.

Based on the above research, for a better model performance, the present application not only provides a novel target skeleton as shown in FIG. 4, but also provides a possible implementation of step 15, in which when the motion capture data hereinbefore is used for describing the predicted posture of the second part (e.g. a whole body) under the target skeleton, step 15 may include steps 151-152 hereinafter.
Step 151: acquiring a three-dimensional mesh (e.g., Mesh) corresponding to the two-dimensional image, where the three-dimensional mesh is configured for describing an actual posture of the whole body of the object in the three-dimensional space.

It should be noted that the present application does not limit the acquisition of the three-dimensional mesh, for example, it may refer to a mesh pre-bound to the two-dimensional image and used for describing an actual body posture of the object in the two-dimensional image within the three-dimensional space. In addition, the present application does not limit the implementation of the three-dimensional mesh, for example, it may be implemented by using any three-dimensional human body model, such as any SMPL (Skinned Multi-Person Linear Model).
Step 152: determining label information corresponding to the two-dimensional image according to skeleton information of the three-dimensional mesh under the target skeleton and the body part of the object located within the target region, so that the label information is configured for indicating an actual posture of the body part under the target skeleton.

The skeleton information of the three-dimensional mesh under the target skeleton is used for representing the body posture presented by the three-dimensional mesh by using the target skeleton.

In addition, the present application does not limit the determination of the “skeleton information of the three-dimensional mesh under the target skeleton”, for example, it may specifically be: mapping the three-dimensional mesh to the target skeleton according to a predetermined mapping matrix to obtain the skeleton information of the three-dimensional mesh under the target skeleton. The mapping matrix may refer to a skeleton point regression matrix that needs to be used for mapping a three-dimensional mesh in a specific posture (e.g., T posture) to a target skeleton, where the three-dimensional mesh is manually bound with the target skeleton by related personnel and which is solved by least squares estimation, so that the mapping matrix can accurately describe a mapping relationship between the three-dimensional mesh and target skeleton points.

Furthermore, the present application does not limit the implementation of step 152, for example, it may specifically be: after acquiring the skeleton information of the three-dimensional mesh under the target skeleton, searching, from the skeleton information, information of each skeleton point involved in the “body part of the object located within the target region” as the label information corresponding to the two-dimensional image.

Based on the related contents of steps 151 to 152 hereinbefore, it can be seen that in the present application, by directly binding the three-dimensional mesh in the database to the target skeleton used by the skeleton detection model, the label information that needs to be used by the skeleton detection model is acquired, which can effectively solve defects caused by different three-dimensional meshes having different skeletons in the database, thereby helping to improve the model performance.

Through research, it has been found that in some scenarios, such as scenarios where a body box between adjacent frames is obtained by inference, a body box (e.g., a bounding box used for region 3 in FIG. 5) determined for one image may be inaccurate, so that a body described by the image is unable to fall completely within the body box, thereby making the motion capture data determined based on the body box inaccurate.

Based on the above research, in order to better improve the accuracy, the present application further provides a possible implementation of the above data processing method, in which the data processing method may include steps 21-25 hereinafter.
Step 21: acquiring a two-dimensional image, which is configured for describing a posture of a first part of an object in a two-dimensional space, and acquiring position information of the object in the two-dimensional image (e.g., determining position information of the object in the two-dimensional image according to position information of the object in a previous frame of image corresponding to the two-dimensional image, etc.).

It should be noted that for the related content of step 21, please refer to the related content of the S1 hereinbefore.
Step 22: cropping a region indicated by the position information from the two-dimensional image to obtain a region image, and predicting skeleton information according to the region image, where the skeleton information is configured for describing a posture of a second part of the object in a three-dimensional space, an area of the second part being greater than that of the first part, and the second part including the first part, and the skeleton information includes a planar position and a depth, the planar position being located within the region indicated by the position information.

It should be noted that for the related content of step 22, please refer to the related content of the S2 hereinbefore.
Step 23: updating, if the skeleton information represents that the first part does not fall completely within the region indicated by the position information (e.g. region 3 shown in FIG. 5), the position information according to a relative position relationship between a part (e.g. head shown in FIG. 5) in the first part that falls outside the region indicated by the position information and a part (e.g. body and arms shown in FIG. 5) in the first part that falls within the region indicated by the position information, so that a part in the first part that falls within the region indicated by the position information after the updating is more than a part in the first part that falls within the region indicated by the position information before the updating, and returning to continue executing the step “predicting skeleton information according to the region image” in step 22 and its subsequent steps, where such an iterative loop is performed until it is determined that the first part falls completely within the region (e.g. region 4 shown in FIG. 5) indicated by the position information, where at least one round of iterative update processing for the position information is ended.

Whether the first part falls completely within the region indicated by the position information is determined according to the skeleton information; and the present application does not limit the implementation of the determination, for example, whether the first part falls completely within the region indicated by the position information may be determined according to a confidence in the skeleton information.

It can be seen that when the skeleton information includes the predicted information of each skeleton point and the confidence of each skeleton point, it is determined whether a confidence of the jth skeleton point is lower than a preset confidence threshold, and if the confidence is not lower than the threshold, it may be determined that predicted information of the jth skeleton point is accurate, and thus it may be determined that the jth skeleton point falls within the region indicated by the position information of the current round; if the confidence is lower than the threshold, it may be determined that predicted information of the j-th skeleton point is not very accurate, and thus it may be determined that the j-th skeleton point does not fall within the region indicated by the position information of the current round, where j is a positive integer and j≤the total number of the skeleton points, and based on the inference results, the following steps are performed: determining, if determining that all of the skeleton points in the first part fall within the region indicated by the position information of the current round, that the first part falls completely within the region indicated by the position information of the current round, while determining, if determining that in the first part, there is at least one skeleton point not falling within the region indicated by the position information of the current round, that the first region does not fall completely within the region indicated by the position information of the current round.

In addition, the “relative position relationship between a part in the first part that falls outside the region indicated by the position information and a part in the first part that falls within the region indicated by the position information” is used for describing an orientation (such as top, bottom, left, or right) of the part outside the region with relative to the part within the region, so that it can be subsequently determined, based on the relative position relationship, in which direction to expand the current body box to enclose the part outside the region.

Furthermore, the present application does not limit the acquisition of the relative position relationship, for example, it may be implemented by manual annotation or human-computer interaction.

For another example, in order to better improve the flexibility, acquiring the relative position relationship may be: analyzing the relative position relationship from a reference image (e.g., a previous frame of image or first frame of image) corresponding to the two-dimensional image. The two-dimensional image and the reference image both belong to a same video, an arrangement position of the reference image in the video is prior to that of the two-dimensional image in the video, and the reference image includes the first part (e.g., upper body as shown in FIG. 5).

It should be noted that the present application does not limit the implementation of the reference image, for example, the reference image may refer to one frame of image existing in the video, including at least the first part, and closest to the two-dimensional image, so that the relative position relationship determined based on the reference image is more accurate.

In addition, the present application does not limit the implementation of the step “updating the position information” in step 23 hereinbefore, for example, it may be an expansion and update according to a preset expansion ratio.

For another example, in order to better improve the efficiency, the step “updating the position information according to a relative position relationship between a part in the first part that falls outside the region indicated by the position information and a part in the first part that falls within the region indicated by the position information” may be: updating the position information according to the relative position relationship and an area of the part in the first part that falls outside the region indicated by the position information, so that an area of a region indicated by the position information after the updating is equal to the sum of the area of the part in the first part that falls outside the region indicated by the position information and the area of the region indicated by the position information before the updating.

It should be noted that, the acquisition of the “area of the part in the first part that falls outside the region indicated by the position information” hereinbefore is similar to the acquisition of the relative position relationship hereinbefore, which will not be repeated here for the sake of brevity.
Step 24: mapping the planar position to a target region by using an objective function to obtain a mapped position, where the objective function is configured for describing a position correspondence between the target region and the region indicated by the position information, the target region is obtained by expanding the region indicated by the position information according to an expansion coefficient, and the objective function is determined according to the expansion coefficient.

It should be noted that for the related content of step 24, please refer to the related content of the S3 hereinbefore.
Step 25: determining motion capture data corresponding to the two-dimensional image according to the mapped position and the depth.

It should be noted that for the related content of step 25, please refer to the related content of the S4 hereinbefore.

Based on the related content of steps 21 to 25 hereinbefore, it can be seen that, in some scenarios, such as live scenarios where a body box of a current frame is determined according to a body box of a previous frame, the body box of the current frame may be optimized by iteratively updating the body box, to overcome defects caused by the body box of the current frame being unable to enclose the whole in-picture body, thereby helping to improve the accuracy.

Through research, it has been found that in some scenarios, the motion capture data not only describes a body posture of one object, but also describes a facial state (e.g., expression) of the object, hence, in order to meet this requirement, the present application further provides a possible implementation of the data processing method, in which the data processing method may include at least steps 31-32 hereinafter.
Step 31: determining face information from the two-dimensional image, so that the face information is configured for describing a face presented in the two-dimensional image.

It should be noted that the present application does not limit the implementation of the face information, for example, the face information may include part or all of expression information, a position of a two-dimensional key point of the face, a position of a three-dimensional key point of the face, a head rotation, and a face mask region. The expression information is used for describing an expression state presented in the two-dimensional image; and the present application does not limit the implementation of the expression information, for example, it may be implemented by using any type of data capable of describing an expression state, such as a blend shape (BS) coefficient. The “position of a two-dimensional key point of the face” is used for describing a state of the face in the two-dimensional image in the two-dimensional space, such as a distribution state of five sense organs. The “position of a three-dimensional key point of the face” is used for describing a state of the face in the two-dimensional image in the three-dimensional space. The “head rotation” is used for describing an orientation of the face in the two-dimensional image. The “face mask region” is used for describing a position of the face in the two-dimensional image.

It should also be noted that the present application does not limit the implementation of step 31, for example, it may specifically be: first, performing face recognition processing on the two-dimensional image to obtain a face position, so that the face position can describe a position of the face in the two-dimensional image; and then performing certain processing (such as expression detection processing+two-dimensional key point detection processing of the face+three-dimensional key point detection processing of the face+head rotation prediction processing) according to the face position and the two-dimensional image, to determine the face information. In addition, the present application does not limit the implementation of each step involved in the determination of the face information, for example, it may be implemented by means of some algorithms or a pre-constructed machine learning model having corresponding functions.

It should be further noted that when step 31 hereinbefore is implemented by means of some machine learning models, in order to better improve the robustness, training data for these machine learning models not only includes data acquired from the database, but also includes augmented data obtained by performing processing (such as camera distortion processing, camera defocusing processing, addition of picture noise, addition of face occlusion, addition of glasses to a face, adjustment of light) on the data in the database, so that the augmented data can simulate many real scenarios such as camera distortion, camera defocusing, existence of image noise, existence of face occlusion, existence of wearing glasses, different light rays, thereby enabling the machine learning models trained based on the data in the database and the augmented data to have higher robustness, and then enabling these models to better apply to complex and ever-changing real live scenarios.
Step 32: determining motion capture data corresponding to the two-dimensional image according to the face information, the mapped position and the depth, so that the motion capture data not only includes information of some skeleton points, but also includes the face information, thereby enabling the motion capture data to not only describe the body posture of the object in the two-dimensional image in the three-dimensional space, but also describe the face state of the object.

Based on the related content of steps 31 to 32 hereinbefore, it can be seen that, for some scenarios, such as scenarios of focusing on a body posture and a face state at the same time, after a two-dimensional image is acquired, not only information (e.g., a mapped position of each skeleton point+a depth of each skeleton point+a rotation of each skeleton point) for describing the body posture, but also information (such as an expression coefficient) for describing the face state are analyzed from the two-dimensional image, so that motion capture data determined based on these two types of information can more comprehensively describe the state presented by the object in the two-dimensional image.

Through research, it has been found that in some scenarios, in the two-dimensional image, the face may be in an occlusion state, so that the expression information analyzed from the two-dimensional image may be inaccurate, hence, in order to overcome the above problem, the present application further provides a possible implementation of the data processing method, in which the data processing method may at least include steps 41 to 43 hereinafter.
Step 41: determining, from the two-dimensional image, expression information, which is configured for describing an expression of a face of the object in the two-dimensional image, the face including a plurality of partitions, and analyzing an occlusion area of each of the partitions from the two-dimensional image.

The expression information (e.g., a 52-dimensional expression coefficient) is obtained by performing expression detection processing on the two-dimensional image, so that the expression information is used for describing the expression of the face of the object in the two-dimensional image. It should be noted that the present application does not limit the determination of the expression information, for example, it may be implemented by using any existing or future emerging method that can detect an expression state from an image, such as by means of a machine learning model having an expression detection function.

The plurality of partitions are obtained by dividing the face, so that the plurality of partitions meet at least the following constraints: an association between key points in the same partition being high, and an association between key points in different partitions being low, so that different partitions remain as decoupled from each other as possible, thereby maintaining a relatively harmonious and natural face state even when adjusting the expression state of an individual partition separately.

In addition, the present application does not limit the implementation of the plurality of partitions, for example, they may include five partitions: a mouth partition, a left eye partition, a right eye partition, a left eyebrow partition, and a right eyebrow partition.

Furthermore, for any of the partitions in the face, after the two-dimensional image is acquired, an occlusion area of the partition may be analyzed from the two-dimensional image, so that the occlusion area can represent whether the partition is occluded seriously, to subsequently enable whether there is a need to perform adjustment for an expression state of the partition to be determined based on the occlusion area.

Moreover, the present application does not limit the determination of the occlusion area, for example, it may be implemented by using manual annotation.

For another example, in order to better improve the flexibility, the occlusion area of each partition is obtained by processing the two-dimensional image by a pre-trained occlusion detection model. The occlusion detection model is used for predicting an occlusion area of each partition of a face in one image, and the occlusion detection model is trained by using a sample image and label information corresponding to the sample image, where at least one face occlusion region exists in the sample image, and the label information corresponding to the sample image is used for indicating an area of each face occlusion area.

It should be noted that the present application does not limit the acquisition of the sample image and its corresponding label information, for example, it may specifically include at least: first, selecting, from a database, an image where face occlusion exists as a sample image, and determining label information corresponding to the sample image by manual annotation of a face occlusion region for the image, so that the label information can describe an area of each face occlusion region in the image.

For another example, in some scenarios, in order to better improve the generalization, the acquisition of the sample image and its corresponding label information may include at least: first, selecting, from a database, some images where face occlusion does not exist; then, integrating the selected image and an image for describing an occlusion into an image where face occlusion exists as a sample image; and then, determining label information corresponding to the sample image according to the image for describing the occlusion, so that the label information can describe an area of each face occlusion region in the image, to subsequently enable training data augmentation on the occlusion detection model by using the data, which makes the finally trained occlusion detection model have better performance and generalization.

Based on the related content of step 41 hereinbefore, it can be seen that, after the two-dimensional image is acquired, it is possible to perform expression prediction processing on the two-dimensional image to obtain expression information, and analyze occlusion areas of partitions of a face from the two-dimensional image, to subsequently enable whether expression states of the partitions described by the expression information are accurate to be determined based on the occlusion areas.
Step 42: updating, for any of the partitions, the expression information according to preset information corresponding to the partition if the occlusion area of the partition reaches a preset threshold, so that the updated expression information includes the preset information corresponding to the partition, where the preset information corresponding to the partition is configured for describing a state of the partition under a preset expression.

For any of the partitions of the face, after an occlusion area of the partition is acquired, it is determined whether the occlusion area reaches a preset threshold. If it does not reach the preset threshold, it may be determined that the partition is not occluded or only a small part of the partition is occluded, and thus it may be determined that expression prediction of the partition is hardly influenced by occlusion, and then it may be determined that an expression state predicted for the partition is accurate. However, if it reaches the preset threshold, it may be determined that a large part of the partition is occluded, and thus it may be determined that expression prediction of the partition is seriously influenced by occlusion, and then it may be determined that an expression state predicted for the partition is inaccurate. Hence, in order to overcome adverse effects (such as occurrence of unreasonable expressions) caused by this problem, the above expression information can be updated according to preset information corresponding to the partition, so that the updated expression information includes the preset information corresponding to the partition, and thus an expression state described by the updated expression information for the partition is an expression state described by the preset information corresponding to the partition, rather than the expression state predicted for the partition, which can effectively overcome the problem caused by the face occlusion.

In addition, for any of the partitions of the face, the preset information corresponding to the partition refers to information (e.g., an expression coefficient) which is preset for the partition and is used for describing a state of the partition under a preset expression; and the present application does not limit the preset information. For example, the prediction information is used for describing a state of the partition under a neutral expression. It can be seen that in a possible implementation, the preset expression may be implemented by using a neutral expression, or by using another expression. The neutral expression refers to a face state for describing expressionlessness.

Furthermore, the present application does not limit the implementation of step 42, for example, when the expression information hereinbefore includes an expression prediction result of each partition, step 42 may specifically be: replacing, for any of the partitions, the expression prediction result of the partition in the expression information with preset information corresponding to the partition if the occlusion area of the partition reaches a preset threshold, to obtain updated expression information, so that the updated expression information includes the preset information corresponding to the partition, and the updated expression information does not include the expression prediction result of the partition.

Based on the related content of step 42 hereinbefore, it can be seen that after the expression information and the occlusion areas of the partitions are acquired, it may be determined, according to the occlusion areas, which data in the expression information is inaccurate, to subsequently enable the inaccurate data to be replaced with some preset data, which can effectively overcome face abnormality caused by the inaccurate data.
Step 43: determining motion capture data corresponding to the two-dimensional image according to the expression information, the mapped position and the depth, so that the motion capture data not only includes information of some skeleton points, but also includes the expression information, and thus the motion capture data can accurately describe the state (such as an expression state+body posture) of the object in the two-dimensional image.

Based on the related content of steps 41 to 43 hereinbefore, it can be seen that in the present application, by predicting an occlusion area of each partition in a face, it is determined whether abnormal data exists in expression information predicted for the face, to subsequently enable the expression information to be optimized by resetting the abnormal data in the expression information to preset normal data, which can effectively ensure the expression prediction effect, e.g., avoiding occurrence of phenomena such as abnormal expressions and abrupt expression transitions.

Through research, it has been found that in some scenarios, such as live scenarios where an image acquired in real time is transformed to motion capture data in real time, each image is processed separately, so that there may be some jitters between a processing result (e.g., expression information) obtained for the image and a processing result of a historically processed image.

In order to overcome the above problems, the present application provides a solution: if the two-dimensional image is not a first frame of image, it may be determined that a previous frame of image corresponding to the two-dimensional image exists, hence, after expression information is determined from the two-dimensional image, smoothing processing (e.g., smoothing processing based on an exponential moving average method) may be performed for the “determining expression information from the two-dimensional image” according to expression information corresponding to the previous frame of image, to obtain expression information corresponding to the two-dimensional image, so that the expression information corresponding to the two-dimensional image exhibits temporally fine and smooth natural expressions. The smoothing processing based on the exponential moving average method should not introduce significant latency, ensuring that the processing process implemented based on the smoothing processing maintains better real-time performance. In addition, for the face information determined from the two-dimensional image, when the head rotation in the face information is not accurate, an unreasonable head posture may occur. Hence, in order to overcome this problem, a head rotation constraint range (such as a constraint range for three rotation axes: pitch, yaw, roll) may be analyzed from a large number of relatively reasonable head rotations, so that the range can accurately represent a constraint that needs to be met by a reasonable head rotation, to determine, after the face information is determined from the two-dimensional image, whether the head rotation in the face information belongs to the head rotation constraint range. If it belongs to the range, it may be determined that the head rotation in the face information is reasonable, and thus it can be determined that the head rotation in the face information is accurate. If it does not belong to the range, it may be determined that the head rotation in the face information is unreasonable, and thus it may be determined that the head rotation in the face information is inaccurate. Hence, in order to avoid occurrence of a head motion meeting a body motion amplitude limit, it is possible to search, from the head rotation constraint range, a head rotation closest to the head rotation in the face information, and update the face information by using the closest head rotation, so that the updated face information includes the closest head rotation, which helps to improve the determination effect of the motion capture data.

It should be noted that the yaw is a rotation of the object around a vertical axis (e.g., z-axis), also called as a yaw angle; the pitch is a rotation of the object around a horizontal axis (y-axis), also called as a pitch angle; and the roll is a rotation of the object around a longitudinal axis (x-axis), also called as a roll angle.

Through research, it has been found that, for face information, for some images, a face cannot be detected, so that face information determined based on the images is inaccurate, and thus a head rotation in the face information is also inaccurate. Hence, in order to avoid output of abnormal head motions in face misdetection, the present application further provides a possible implementation of the data processing method, in which the data processing method may include at least steps 51 to 52 hereinafter.
Step 51: determining, in response to failure to detect the face of the object from the two-dimensional image (e.g., a 9th frame of image), a head rotation corresponding to the two-dimensional image according to a head rotation predicted from a preceding image (e.g., an 8th frame of image) corresponding to the two-dimensional image. The two-dimensional image and the preceding image both belong to the same video, and an arrangement position of the preceding image in the video is prior to that of the two-dimensional image in the video.

The preceding image corresponding to the two-dimensional image refers to an image which exists in the video, where the face of the object can be detected, of which an arrangement position is prior to that of the two-dimensional image, and which is closest to the two-dimensional image; and the head rotation predicted from the preceding image is used for describing an orientation of the face in the preceding image, so that the head rotation can represent an orientation closest to the orientation of the face in the two-dimensional image.

In addition, the present application does not limit the acquisition of the preceding image corresponding to the two-dimensional image. For example, when face information determined from one image includes a face confidence, and the face confidence is used for indicating whether a face described by the face information is accurate, if the two-dimensional image is an ith frame of image of a video, determining the preceding image may be: determining whether an image for which a face confidence exceeds a threshold exists in first i−1 frames of images of the video, and if the image exists, searching, from the image for which the face confidence exceeds the threshold, an image closest to the two-dimensional image as the preceding image corresponding to the two-dimensional image. Therein, i is a positive integer.

Furthermore, the present application does not limit the implementation of step 51, for example, it may specifically be: determining, in response to failure to detect the face of the object from the two-dimensional image, a head rotation predicted from a preceding image corresponding to the two-dimensional image as a head rotation corresponding to the two-dimensional image.

Moreover, the present application does not limit the determination of the “failure to detect the face of the object from the two-dimensional image” in step 51. For example, when the face information determined from the two-dimensional image includes a face confidence, if the face confidence does not exceed a threshold, it may be determined that the face information determined from the image is inaccurate, and thus failure to detect the face of the object from the two-dimensional image may be determined, and then failure to determine a head rotation from the two-dimensional image may be determined. Hence, a head rotation for an image in the same video for which a face confidence is high and which is closest to the two-dimensional image may be used as a head rotation corresponding to the two-dimensional image, to avoid abnormal head motions caused by face misdetection.
Step 52: determining motion capture data corresponding to the two-dimensional image according to the head rotation corresponding to the two-dimensional image, the mapped position, and the depth, so that the motion capture data not only includes information of some skeleton points, but also includes the head rotation.

Based on the related content of steps 51 to 52 hereinbefore, it can be seen that in failure to detect a face from a two-dimensional image, a head rotation for an image in the same video for which a face confidence is high and which is closest to the two-dimensional image may be used as a head rotation corresponding to the two-dimensional image, to avoid abnormal head motions caused by face misdetection.

In addition, in order to better improve the accuracy, the present application further provides determination of the “failure to detect the face of the object from the two-dimensional image” in step 51, which includes: determining, according to at least one type of data determined from the two-dimensional image, whether the face of the object is detected from the two-dimensional image. Different data in the at least one type of data is used for describing different features of the face, and the at least one type of data may include part or all of a face probability, a face segmentation region, a head rotation, and a face identifier (ID), the face probability being used for indicating a probability of the face existing in the two-dimensional image, the face segmentation region being used for indicating a position of the face in the two-dimensional image, the head rotation being used for indicating an orientation of the face in the two-dimensional image, and the face identifier (Identity Document, ID) being used for indicating facial features of the face in the two-dimensional image.

Furthermore, the present application does not limit the implementation of the step “determining, according to at least one type of data determined from the two-dimensional image, whether the face of the object is detected from the two-dimensional image”. For example, when the at least one type of data may include a face probability, a face segmentation region, a head rotation, and a face identifier, the step may specifically be: determining failure to detect the face of the object from the two-dimensional image if the face probability does not exceed a preset probability threshold, an area of the face segmentation region does not exceed a preset area threshold, the head rotation determined from the two-dimensional image does not meet a preset head rotation constraint, or the face identifier determined from the two-dimensional image is inconsistent with a face identifier determined from the preceding image corresponding to the two-dimensional image. However, determining that the face of the object is detected from the two-dimensional image if the face probability exceeds a preset probability threshold, an area of the face segmentation region exceeds a preset area threshold, the head rotation determined from the two-dimensional image meets a preset head rotation constraint, and the face identifier determined from the two-dimensional image is consistent with a face identifier determined from the preceding image.

Moreover, in order to better improve the efficiency, the present application further provides determination of the “failure to detect the face of the object from the two-dimensional image” in the step 51, which includes part or all of: determining whether a face probability determined from the two-dimensional image exceeds a preset probability threshold, and determining failure to detect the face of the object from the two-dimensional image if the face probability does not exceed the preset probability threshold; determining whether an area of a face segmentation region determined from the two-dimensional image exceeds a preset area threshold if the face probability exceeds the preset probability threshold; determining failure to detect the face of the object from the two-dimensional image if the area of the face segmentation region does not exceed the preset area threshold; determining whether a head rotation predicted from the two-dimensional image meets a preset head rotation constraint if the area of the face segmentation region exceeds the preset area threshold; determining failure to detect the face of the object from the two-dimensional image if the predicted head rotation does not meet the preset head rotation constraint; determining whether a face identifier determined from the two-dimensional image is consistent with a face identifier determined from the preceding image corresponding to the two-dimensional image if the predicted head rotation meets the preset head rotation constraint; determining failure to detect the face of the object from the two-dimensional image if the face identifier determined from the two-dimensional image is inconsistent with the face identifier determined from the preceding image; and determining that the face of the object is detected from the two-dimensional image if the face identifier determined from the two-dimensional image is consistent with the face identifier determined from the preceding image, which enables a multi-condition cascade approach to determine whether a face can be detected in an image, thereby significantly improving the reliability of inference results, and then helping to better solve the problem of expression or head motion jumps caused by misdetection of face detection in scenarios such as rapid face motions.

Through research, it has been found that if a face cannot be detected in consecutive multi-frames of images in the same video, it may result in a significant difference in head rotation between the last successfully detected face and the next detectable one, so that when the head rotations for the consecutive multi-frames of images are determined by reusing the head rotation of the last successfully detected face, a significant discontinuity in head rotation may occur between the last frame of image where face detection failed and the next successfully detected frame of image, which results in head motion jumps.

In order to overcome the above problems, the present application further provides a possible implementation of the data processing method, in which when the two-dimensional image (e.g. a 15th frame of image), a plurality of first images (e.g. 9th to 14th frame of images) having consecutive arrangement positions, and a second image (e.g. an 8th frame of image) all belong to a same video, an arrangement position of the second image in the video is prior to that of each first image in the video, the arrangement position of each first image in the video is prior to that of the two-dimensional image in the video, and with failure to detect the face of the object from each first image, a head rotation corresponding to each first image reuses a head rotation predicted from the second image, the data processing method may include at least steps 61 to 62 hereinafter.
Step 61: in response to detecting the face of the object from the two-dimensional image, performing interpolation processing according to a head rotation predicted from the second image (e.g., head rotation 1) and the head rotation predicted from the two-dimensional image (e.g., head rotation 2), to obtain an interpolation processing result, so that the interpolation processing result includes a plurality of head rotations arranged in sequence, and each head rotation in the plurality of head rotations is between the head rotation predicted from the second image and the head rotation predicted from the two-dimensional image.

It should be noted that the present application does not limit the implementation of step 61, for example, it may be implemented by using any interpolation method.

It should also be noted that the present application does not limit the number of head rotations in the interpolation processing result, for example, it may be determined according to actual application scenarios. For another example, in order to better improve the effect, the number of head rotations in the interpolation processing result may be determined according to the number of images in the plurality of first image having consecutive arrangement positions hereinbefore (for example, the two numbers are the same), to better achieve the smoothing effect.
Step 62: determining a head rotation corresponding to the two-dimensional image (e.g., a 15th frame of image) and a head rotation corresponding to at least one third image (e.g., 16th-20th frames of images) respectively according to the interpolation processing result, and determining the head rotation predicted from the two-dimensional image as a head rotation corresponding to a fourth image (e.g., a 21st frame of image), where the arrangement position of the two-dimensional image in the video is prior to that of each third image in the video, the arrangement position of each third image in the video is prior to that of the fourth image in the video, so that motion capture data corresponding to the two-dimensional image includes the head rotation corresponding to the two-dimensional image, motion capture data corresponding to each third image includes the head rotation corresponding to each third image, and motion capture data corresponding to the fourth image includes the head rotation corresponding to the fourth image, and thus, for any of the images in the video, motion capture data corresponding to the image is determined according to a head rotation corresponding to the image.

It should be noted that the present application does not limit the implementation of the step “determining a head rotation corresponding to the two-dimensional image and a head rotation corresponding to at least one third image respectively according to the interpolation processing result”, for example, it may specifically be: using a head rotation in a first position in the interpolation processing result as the head rotation corresponding to the two-dimensional image, while the remaining head rotations from the interpolation processing result are sequentially designated as the corresponding head rotations for at least one third image arranged in order.

It can be seen that the number of images in the at least one third image is determined according to the number of head rotations in the interpolation processing result, for example, the number of images in the at least one third image=the number of head rotations in the interpolation processing result −1.

Based on the related content of steps 61 to 62 hereinbefore, it can be seen that for a same video, when there is a process of changing from detection of no face to detection of a face in the video, in order to avoid occurrence of head motion jumps, an interpolation smooth transition processing of a short-time head motion may be added for the video, so that for the head motion, a smooth and natural performance can be presented in the process.

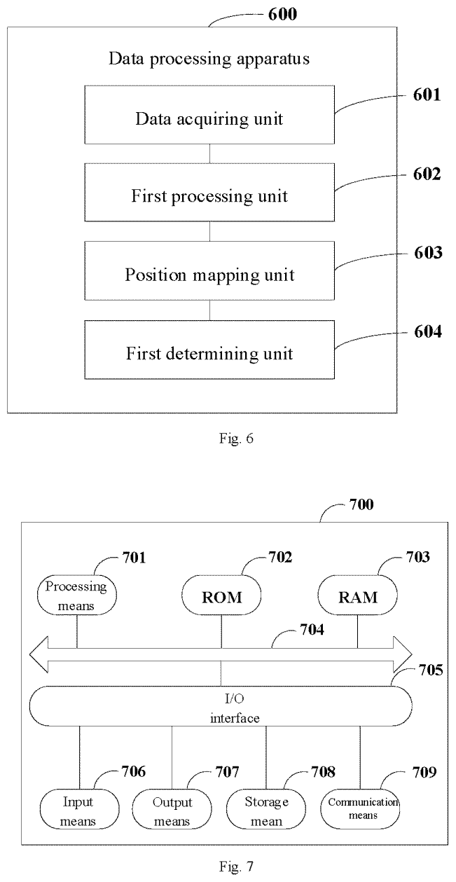

Based on the data processing method provided in the embodiment of the present application, an embodiment of the present application further provides a data processing apparatus, which is explained and illustrated with reference to FIG. 6 below. FIG. 6 is a schematic structural diagram of a data processing apparatus according to an embodiment of the present application. It should be noted that for the technical details of the data processing apparatus according to the embodiment of the present application, please refer to the related content of the data processing method hereinbefore.

As shown in FIG. 6, the data processing apparatus 600 according to the embodiment of the present application includes:
a data acquiring unit 601 configured to acquire a two-dimensional image, which is configured for describing a posture of a first part of an object in a two-dimensional space, and acquire position information of the object in the two-dimensional image;
a first processing unit 602 configured to crop a region indicated by the position information from the two-dimensional image to obtain a region image, and predict skeleton information according to the region image, where the skeleton information is configured for describing a posture of a second part of the object in a three-dimensional space, an area of the second part being greater than that of the first part, the second part including the first part, and the skeleton information includes a planar position and a depth, the planar position being located within the region indicated by the position information;
a position mapping unit 603 configured to map the planar position to a target region by using an objective function to obtain a mapped position, where the objective function is configured for describing a position correspondence between the target region and the region indicated by the position information, the target region is obtained by expanding the region indicated by the position information according to an expansion coefficient, and the objective function is determined according to the expansion coefficient; and a first determining unit 604 configured to determine motion capture data corresponding to the two-dimensional image according to the mapped position and the depth.

In a possible implementation, the skeleton information is obtained by processing the region image by a skeleton detection model; and
the data processing apparatus 600 further includes:
a second determining unit configured to determine label information corresponding to the two-dimensional image according to a body part of the object located within the target region, where the label information is configured for describing an actual posture of the body part in the three-dimensional space, the body part is part or all of the second part, an area of the body part is greater than that of the first part, and the body part includes the first part; and
a model updating unit configured to update the skeleton detection model according to a difference between the motion capture data and the label information.

In a possible implementation, the motion capture data is configured for describing a predicted posture of the second part under a target skeleton; and the second determining unit is specifically configured to: acquire a three-dimensional mesh corresponding to the two-dimensional image, where the three-dimensional mesh is configured for describing an actual posture of a whole body of the object in the three-dimensional space; and determine the label information according to skeleton information of the three-dimensional mesh under the target skeleton and the body part of the object located within the target region, where the label information is configured for indicating an actual posture of the body part under the target skeleton.

In a possible implementation, the data processing apparatus 600 further includes: a position updating unit configured to, after the predicting the skeleton information according to the region image, update, in response to that the skeleton information represents that the first part does not fall completely within the region indicated by the position information, the position information according to a relative position relationship between a part in the first part that falls outside the region indicated by the position information and a part in the first part that falls within the region indicated by the position information, so that a part in the first part that falls within the region indicated by the position information after the updating is more than a part in the first part that falls within the region indicated by the position information before the updating, and by returning to the first processing unit 602, the step of predicting the skeleton information according to the region image is continued to be performed.

In a possible implementation, the data processing apparatus 600 further includes: a relationship analysis unit configured to analyze the relative position relationship from a reference image corresponding to the two-dimensional image, where the two-dimensional image and the reference image both belong to a same video, an arrangement position of the reference image in the video is prior to that of the two-dimensional image in the video, and the reference image includes the first part.

In a possible implementation, the data acquiring unit 601 is specifically configured to: determine the position information of the object in the two-dimensional image according to position information of the object in a previous frame of image corresponding to the two-dimensional image, where the two-dimensional image and the previous frame of image both belong to a same video, an arrangement position of the previous frame of image in the video is prior to that of the two-dimensional image in the video, and the arrangement position of the previous frame of image in the video is adjacent to that of the two-dimensional image in the video.

In a possible implementation, the data processing apparatus 600 further includes:
a third determining unit configured to determine expression information from the two-dimensional image, where the expression information is configured for describing an expression of a face of the object, the face including a plurality of regions, and analyze an occlusion area of each of the partitions from the two-dimensional image;
an information updating unit configured to update, for any of the partitions, the expression information according to preset information corresponding to the partition in response to that the occlusion area of the partition reaches a preset threshold, so that the updated expression information includes the preset information, where the preset information is configured for describing a state of the partition under a preset expression; and
the first determining unit 604 is specifically configured to: determine the motion capture data corresponding to the two-dimensional image according to the expression information, the mapped position, and the depth.

In a possible implementation, the occlusion area of each of the partitions is obtained by processing the two-dimensional image by a pre-trained occlusion detection model, where the occlusion detection model is trained by using a sample image and label information corresponding to the sample image, at least one face occlusion region existing in the sample image, and the label information corresponding to the sample image is configured for indicating an area of each of the face occlusion region.

In a possible implementation, the data processing apparatus 600 further includes:
a fourth determining unit configured to determine, in response to failure to detect the face of the object from the two-dimensional image, a head rotation corresponding to the two-dimensional image according to a head rotation predicted from a preceding image corresponding to the two-dimensional image, where the two-dimensional image and the preceding image both belong to a same video, and an arrangement position of the preceding image in the video is prior to that of the two-dimensional image in the video; and
the first determining unit 604 is specifically configured to: determine the motion capture data corresponding to the two-dimensional image according to the head rotation corresponding to the two-dimensional image, the mapped position, and the depth.

In a possible implementation, the data processing apparatus 600 further includes:
a fifth determining unit configured to determine, according to at least one type of data determined from the two-dimensional image, whether the face of the object is detected from the two-dimensional image, where different data in the at least one type of data is configured for describing different features of the face, and the at least one type of data includes part or all of a face probability, a face segmentation region, a head rotation, and a face identifier, the face probability being configured for indicating a probability that the face exists in the two-dimensional image, the face segmentation region being configured for indicating a position of the face in the two-dimensional image, the head rotation being configured for indicating an orientation of the face in the two-dimensional image, and the face identifier being configured for indicating facial features of the face in the two-dimensional image.

In a possible implementation, the fifth determining unit is specifically configured to: determine failure to detect the face of the object from the two-dimensional image in response to that the face probability does not exceed a preset probability threshold, an area of the face segmentation region does not exceed a preset area threshold, the head rotation determined from the two-dimensional image does not meet a preset head rotation constraint, or the face identifier determined from the two-dimensional image is inconsistent with a face identifier determined from the preceding image; and determine that the face of the object is detected from the two-dimensional image in response to that the face probability exceeds the preset probability threshold, the area of the face segmentation region exceeds the preset area threshold, the head rotation determined from the two-dimensional image meets the preset head rotation constraint, and the face identifier determined from the two-dimensional image is consistent with the face identifier determined from the preceding image.

In a possible implementation, the data processing apparatus 600 further includes a second processing unit, and the second processing unit is configured to perform some or all of: determining whether a face probability determined from the two-dimensional image exceeds a preset probability threshold, where the face probability is configured for indicating a probability that the face exists in the two-dimensional image; determining failure to detect the face of the object from the two-dimensional image in response to that the face probability does not exceed the preset probability threshold; determining whether an area of a face segmentation region determined from the two-dimensional image exceeds a preset area threshold in response to that the face probability exceeds the preset probability threshold, where the face segmentation region is configured for indicating a position of the face in the two-dimensional image; determining failure to detect the face of the object from the two-dimensional image in response to that the area of the face segmentation region does not exceed the preset area threshold; determining whether a head rotation predicted from the two-dimensional image meets a preset head rotation constraint in response to that the area of the face segmentation region exceeds the preset area threshold, where the predicted head rotation is configured for indicating an orientation of the face in the two-dimensional image; determining failure to detect the face of the object from the two-dimensional image in response to that the predicted head rotation does not meet the preset head rotation constraint; determining whether a face identifier determined from the two-dimensional image is consistent with a face identifier determined from the preceding image in response to that the predicted head rotation meets the preset head rotation constraint, where the face identifier is configured for describing facial features of the face; determining failure to detect the face of the object from the two-dimensional image in response to that the face identifier determined from the two-dimensional image is inconsistent with the face identifier determined from the preceding image; and determining that the face of the object is detected from the two-dimensional image in response to that the face identifier determined from the two-dimensional image is consistent with the face identifier determined from the preceding image.

In a possible implementation, the two-dimensional image, a plurality of first images having consecutive arrangement positions, and a second image all belong to a same video, an arrangement position of the second image in the video is prior to that of each of the first images in the video, the arrangement position of each of the first images in the video is prior to that of the two-dimensional image in the video, and with failure to detect the face of the object from each of the first images, a head rotation corresponding to each of the first images reuses a head rotation predicted from the second image; and the data processing apparatus 600 further includes: a third processing unit configured to perform, in response to detecting the face of the object from the two-dimensional image, interpolation processing according to the head rotation predicted from the second image and a head rotation predicted from the two-dimensional image, to obtain an interpolation processing result, where the interpolation processing result includes a plurality of head rotations arranged in sequence, each of the plurality of head rotations being between the head rotation predicted from the second image and the head rotation predicted from the two-dimensional image; and determine a head rotation corresponding to the two-dimensional image and a head rotation corresponding to at least one third image respectively according to the interpolation processing result, and determine the head rotation predicted from the two-dimensional image as a head rotation corresponding to a fourth image, where the arrangement position of the two-dimensional image in the video is prior to that of each of the third image in the video, and the arrangement position of each of the third image in the video is prior to that of the fourth image in the video, where for any of the images in the video, motion capture data corresponding to the image is determined according to a head rotation corresponding to the image.

In a possible implementation, the first part is an upper body and the second part is the whole body.

Based on the related content of the data processing apparatus 600, it can be seen that the operation principle of the apparatus 600 includes: first, acquiring a two-dimensional image, so that the two-dimensional image is used for describing a posture of a first part (e.g., an upper body) of an object in a two-dimensional space, and acquiring position information (such as a body detection box) of the object in the two-dimensional image; then cropping a region indicated by the position information from the two-dimensional image to obtain a region image, so that the region image can better describe the posture of the first part with as little background interference as possible; then, predicting skeleton information according to the region image, so that the skeleton information is used for describing a posture of a second part (e.g., a whole body) of the object in a three-dimensional space, the skeleton information including a planar position and a depth, and the planar position being located within the region indicated by the position information, and thus the skeleton information can describe a position of each skeleton point in the second part within the region indicated by the position information; then, mapping, by using an objective function, the planar position to a target region obtained by expanding the region indicated by the position information to obtain a mapped position, so that the mapped position can describe a position of each skeleton point in the second part within the target region; and finally, determining motion capture data corresponding to the two-dimensional image according to the mapped position and the depth, so that the motion capture data can not only describe a state of a body part (e.g., an upper body) occurring in the two-dimensional image, but also describe a state of a body part (e.g., a lower body) not occurring in the two-dimensional image, thereby enabling the effect of predicting the in-picture and out-picture body parts, and then enabling defects (e.g., defects such as jitters caused by failure to predict the out-picture body part) caused by occurrence of only part of the body in the two-dimensional image to be effectively overcome, which helps to improve the determination effect of the motion capture data.

In addition, an embodiment of the present application further provides an electronic device, including a processor and a memory: the memory being configured to store instructions or a computer program; and the processor being configured to execute the instructions or computer program in the memory to cause the electronic device to execute any implementation of the data processing method provided in the embodiments of the present application.

Referring to FIG. 7, a schematic structural diagram of an electronic device 700 suitable for implementing an embodiment of the present disclosure is shown. A terminal device in the embodiment of the present disclosure may include, but is not limited to, a mobile terminal such as a mobile phone, laptop, digital broadcast receiver, PDA (Personal Digital Assistant), PAD (Portable Android Device), PMP (Portable Multimedia Player), and vehicle-mounted terminal (e.g., vehicle-mounted navigation terminal), and a fixed terminal such as a digital TV and desk computer. The electronic device shown in FIG. 7 is only an example, and should not bring any limitation to the functions and the scope of use of the embodiment of the present disclosure.

As shown in FIG. 7, the electronic device 700 may include a processing means (e.g., central processing unit, graphics processing unit, etc.) 701 that may perform various appropriate actions and processes according to a program stored in a read only memory (ROM) 702 or a program loaded from a storage means 708 into a random access memory (RAM) 703. In the RAM703, various programs and data required for the operation of the electronic device 700 are also stored. The processing means 701, the ROM 702, and the RAM 703 are connected to each other by a bus 704. An input/output (I/O) interface 705 is also connected to the bus 704.

Generally, the following means may be connected to the I/O interface 705: an input means 706 including, for example, a touch screen, touch pad, keyboard, mouse, camera, microphone, accelerometer, gyroscope, etc.; an output means 707 including, for example, a liquid crystal display (LCD), speaker, vibrator, etc.; the storage means 708, including, for example, a magnetic tape, hard disk, etc.; and a communication means 709. The communication means 709 may allow the electronic device 700 to communicate with other devices wirelessly or by wire to exchange data. While FIG. 7 illustrates the electronic device 700 having various means, it should be understood that there is no requirement that all illustrated means are implemented or provided. More or fewer means may be alternatively implemented or provided.

In particular, according to the embodiments of the present disclosure, the processes described above with reference to the flow diagrams may be implemented as a computer software program. For example, an embodiment of the present disclosure includes a computer program product including a computer program carried on a non-transitory computer-readable medium, the computer program containing program code for performing the method illustrated by the flow diagrams. In such an embodiment, the computer program may be downloaded and installed from a network via the communication means 709, or installed from the storage means 708, or installed from the ROM 702. The computer program, when executed by the processing means 701, performs the above functions defined in the method of the embodiment of the present disclosure.

The electronic device provided in the embodiment of the present disclosure and the method provided in the above embodiment belong to the same inventive concept, where for technical details that are not described in detail in this embodiment, reference can be made to the above embodiment, and this embodiment has the same beneficial effects as the above embodiment.

An embodiment of the present application further provides a computer-readable medium having therein stored instructions or a computer program which, when run on a device, causes the device to execute any implementation of the data processing method provided in the embodiment of the present application.

It should be noted that the above computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, portable computer diskette, hard disk, random access memory (RAM), read only memory (ROM), erasable programmable read-only memory (EPROM or flash memory), optical fiber, portable compact disc read-only memory (CD-ROM), optical storage device, magnetic storage device, or any suitable combination of the foregoing. In the present disclosure, the computer-readable storage medium may be any tangible medium containing or storing a program, where the program can be used by or in conjunction with an instruction execution system, apparatus, or device. However, in the present disclosure, the computer-readable signal medium may include a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, where the computer-readable signal medium can send, propagate, or transmit a program for use by or in conjunction with an instruction execution system, apparatus, or device. The program code contained on the computer-readable medium may be transmitted using any appropriate medium, including but not limited to: a wire, optical cable, RF (Radio Frequency), etc., or any suitable combination of the foregoing.

In some implementations, a client and a server may communicate using any currently known or future developed network protocol, such as HTTP (Hyper Text Transfer Protocol), and may be interconnected with any form or medium of digital data communication (e.g., a communication network). Examples of the communication network include a local area network (“LAN”), wide area network (“WAN”), internet (e.g., the Internet), and peer-to-peer network (e.g., ad hoc peer-to-peer network), as well as any currently known or future developed network.

The above computer-readable medium may be contained in the above electronic device; or may exist separately without being assembled into the electronic device.

The above computer-readable medium has thereon carried one or more programs which, when executed by the electronic device, cause the electronic device to perform the above method.

Computer program code for performing the operation of the present disclosure may be written in one or more programming languages or a combination thereof, where the above programming language includes but is not limited to an object-oriented programming language such as Java, Smalltalk, and C++, and also includes a conventional procedural programming language, such as a “C” language or similar programming language. The program code may be executed completely on a user's computer, partly on a user's computer, as a stand-alone software package, partly on a user's computer and partly on a remote computer, or completely on a remote computer or server. In a scenario where a remote computer is involved, the remote computer may be connected to a user's computer through any type of network, including a local area network (LAN) or wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or part of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved units described in the embodiments of the present disclosure may be implemented by software or hardware. A name of a unit/module does not, in some cases, constitute a limitation on the unit itself.

The functions described above herein may be executed, at least partially, by one or more hardware logic components. For example, without limitation, a hardware logic component of an exemplary type that may be used includes: a field programmable gate array (FPGA), application specific integrated circuit (ASIC), application specific standard product (ASSP), system on chip (SOC), complex programmable logic device (CPLD), and the like.

In the context of this disclosure, a machine-readable medium may be a tangible medium, which can contain or store a program for use by or in conjunction with an instruction execution system, apparatus, or device. The machine-readable medium may be a machine-readable signal medium or machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, portable computer diskette, hard disk, random access memory (RAM), read only memory (ROM), erasable programmable read-only memory (EPROM or flash memory), optical fiber, portable compact disc read-only memory (CD-ROM), optical storage device, magnetic storage device, or any suitable combination of the foregoing.

It should be noted that, in this description, the embodiments are described in a progressive manner, and each embodiment focuses on differences from other embodiments, and for same and similar parts between the embodiments, reference can be made to each other. For the system or apparatus disclosed by the embodiment, since it corresponds to the method disclosed by the embodiment, the description is simple, and for the relevant points, reference can be made to the description of the method section.

It should be understood that, in the present application, “at least one” refers to one or more, “a plurality” refers to two or more. “And/or”, which is used for describing an association relationship between associated objects, indicates that there may be three relationships, for example, “A and/or B” may represent three cases: the presence of A alone, the presence of B alone, and the presence of A and B simultaneously, where A and B may be singular or plural. A character “/” generally indicates that preceding and succeeding objects associated are in an “or” relationship. “At least one of the following items” or its similar expression refers to any combination of these items, including any combination of the singular or plural items. For example, at least one of a, b, or c, may represent: a, b, c, “a and b”, “a and c”, “b and c”, or “a and b and c”, where a, b and c may be single or plural.

It should be further noted that, relational terms such as “first” and “second”, herein, are only used for distinguishing one entity or operation from another entity or operation without necessarily requiring or implying any such actual relation or order between these entities or operations. Moreover, the term “include”, “including”, or any other variation thereof, is intended to encompass a non-exclusive inclusion, so that a process, method, article, or device including a list of elements not only includes those elements but also includes other elements not expressly listed, or also includes elements inherent to such a process, method, article, or device. Without more limitations, an element defined by a statement “including a . . . ” does not exclude the presence of another identical element in a process, method, article, or device that includes the element.

The steps of the method or algorithm described in conjunction with the embodiments disclosed herein may be implemented directly using hardware, a software module executed by a processor, or a combination of the two. The software module may be provided in a random access memory (RAM), memory, read only memory (ROM), electrically programmable ROM, electrically erasable programmable ROM, register, hard disk, removable disk, CD-ROM, or any other form of storage medium known in the art.

The above description of the disclosed embodiments enables those skilled in the art to implement or use the present application. Various modifications to these embodiments will be readily apparent to those skilled in the art, and the general principles defined herein may be implemented in other embodiments without departing from the spirit or scope of the present application. Therefore, the present application will not be limited to these embodiments shown herein but will conform to the widest scope consistent with the principles and novel features disclosed herein.

1. A data processing method, comprising:
acquiring a two-dimensional image, which is configured for describing a posture of a first part of an object in a two-dimensional space, and acquiring position information of the object in the two-dimensional image;
cropping a region indicated by the position information from the two-dimensional image to obtain a region image, and predicting skeleton information according to the region image, wherein the skeleton information is configured for describing a posture of a second part of the object in a three-dimensional space, an area of the second part being greater than that of the first part, the second part comprising the first part, and the skeleton information comprises a planar position and a depth, the planar position being located within the region indicated by the position information;
mapping the planar position to a target region by using an objective function to obtain a mapped position, wherein the objective function is configured for describing a position correspondence between the target region and the region indicated by the position information, the target region is obtained by expanding the region indicated by the position information according to an expansion coefficient, and the objective function is determined according to the expansion coefficient; and
determining motion capture data corresponding to the two-dimensional image according to the mapped position and the depth.

2. The method according to claim 1, wherein, the skeleton information is obtained by processing the region image by a skeleton detection model; and
the method further comprises:
determining label information corresponding to the two-dimensional image according to a body part of the object located within the target region, wherein the label information is configured for describing an actual posture of the body part in the three-dimensional space, the body part is part or all of the second part, an area of the body part is greater than that of the first part, and the body part comprises the first part; and
updating the skeleton detection model according to a difference between the motion capture data and the label information.

3. The method according to claim 2, wherein, the motion capture data is configured for describing a predicted posture of the second part under a target skeleton; and
acquiring the label information comprises:
acquiring a three-dimensional mesh corresponding to the two-dimensional image, wherein the three-dimensional mesh is configured for describing an actual posture of a whole body of the object in the three-dimensional space; and
determining the label information according to skeleton information of the three-dimensional mesh under the target skeleton and the body part of the object located within the target region, wherein the label information is configured for indicating an actual posture of the body part under the target skeleton.

4. The method according to claim 1, wherein, after the predicting the skeleton information according to the region image, the method further comprises:
updating, in response to that the skeleton information represents that the first part does not fall completely within the region indicated by the position information, the position information according to a relative position relationship between a part in the first part that falls outside the region indicated by the position information and a part in the first part that falls within the region indicated by the position information, so that a part in the first part that falls within the region indicated by the position information after the updating is more than a part in the first part that falls within the region indicated by the position information before the updating, and continuing performing the step of predicting the skeleton information according to the region image.

5. The method according to claim 4, further comprising:
analyzing the relative position relationship from a reference image corresponding to the two-dimensional image, wherein the two-dimensional image and the reference image belong to a same video, an arrangement position of the reference image in the video is prior to that of the two-dimensional image in the video, and the reference image comprises the first part.

6. The method according to claim 4, wherein, the acquiring the position information of the object in the two-dimensional image, comprises:
determining the position information of the object in the two-dimensional image according to position information of the object in a previous frame of image corresponding to the two-dimensional image, wherein the two-dimensional image and the previous frame of image both belong to a same video, an arrangement position of the previous frame of image in the video is prior to that of the two-dimensional image in the video, and the arrangement position of the previous frame of image in the video is adjacent to that of the two-dimensional image in the video.

7. The method according to claim 1, further comprising:
determining, from the two-dimensional image, expression information, which is configured for describing an expression of a face of the object, the face comprising a plurality of partitions, and analyzing an occlusion area of each of the partitions from the two-dimensional image;
updating, for any of the partitions, the expression information according to preset information corresponding to the partition in response to that the occlusion area of the partition reaches a preset threshold, so that the updated expression information comprises the preset information, wherein the preset information is configured for describing a state of the partition under a preset expression; and
the determining the motion capture data corresponding to the two-dimensional image according to the mapped position and the depth, comprises:
determining the motion capture data corresponding to the two-dimensional image according to the expression information, the mapped position, and the depth.

8. The method according to claim 7, wherein, the occlusion area of each of the partitions is obtained by processing the two-dimensional image by a pre-trained occlusion detection model,
wherein the occlusion detection model is trained by using a sample image and label information corresponding to the sample image, at least one face occlusion region existing in the sample image, and the label information corresponding to the sample image being configured for indicating an area of each of the face occlusion region.

9. The method according to claim 1, further comprising:
determining, in response to failure to detect the face of the object from the two-dimensional image, a head rotation corresponding to the two-dimensional image according to a head rotation predicted from a preceding image corresponding to the two-dimensional image, wherein the two-dimensional image and the preceding image both belong to a same video, and an arrangement position of the preceding image in the video is prior to that of the two-dimensional image in the video; and
the determining the motion capture data corresponding to the two-dimensional image according to the mapped position and the depth, comprises:
determining the motion capture data corresponding to the two-dimensional image according to the head rotation corresponding to the two-dimensional image, the mapped position, and the depth.

10. The method according to claim 9, further comprising:
determining, according to at least one type of data determined from the two-dimensional image, whether the face of the object is detected from the two-dimensional image, wherein different data in the at least one type of data is configured for describing different features of the face, and the at least one type of data comprises part or all of a face probability, a face segmentation region, a head rotation, and a face identifier, the face probability being configured for indicating a probability that the face exists in the two-dimensional image, the face segmentation region being configured for indicating a position of the face in the two-dimensional image, the head rotation being configured for indicating an orientation of the face in the two-dimensional image, and the face identifier being configured for indicating facial features of the face in the two-dimensional image.

11. The method according to claim 10, wherein, the determining, according to the at least one type of data determined from the two-dimensional image, whether the face of the object is detected from the two-dimensional image, comprises:
determining failure to detect the face of the object from the two-dimensional image in response to that the face probability does not exceed a preset probability threshold, an area of the face segmentation region does not exceed a preset area threshold, the head rotation determined from the two-dimensional image does not meet a preset head rotation constraint, or the face identifier determined from the two-dimensional image is inconsistent with a face identifier determined from the preceding image;
determining that the face of the object is detected from the two-dimensional image in response to that the face probability exceeds the preset probability threshold, the area of the face segmentation region exceeds the preset area threshold, the head rotation determined from the two-dimensional image meets the preset head rotation constraint, and the face identifier determined from the two-dimensional image is consistent with the face identifier determined from the preceding image.

12. The method according to claim 9, further comprising part or all of:
determining whether a face probability determined from the two-dimensional image exceeds a preset probability threshold, wherein the face probability is configured for indicating a probability that the face exists in the two-dimensional image;
determining failure to detect the face of the object from the two-dimensional image in response to that the face probability does not exceed the preset probability threshold;
determining whether an area of a face segmentation region determined from the two-dimensional image exceeds a preset area threshold in response to that the face probability exceeds the preset probability threshold, wherein the face segmentation region is configured for indicating a position of the face in the two-dimensional image;
determining failure to detect the face of the object from the two-dimensional image in response to that the area of the face segmentation region does not exceed the preset area threshold;
determining whether a head rotation predicted from the two-dimensional image meets a preset head rotation constraint in response to that the area of the face segmentation region exceeds the preset area threshold, wherein the predicted head rotation is configured for indicating an orientation of the face in the two-dimensional image;
determining failure to detect the face of the object from the two-dimensional image in response to that the predicted head rotation does not meet the preset head rotation constraint;
determining whether a face identifier determined from the two-dimensional image is consistent with a face identifier determined from the preceding image in response to that the predicted head rotation meets the preset head rotation constraint, wherein the face identifier is configured for describing facial features of the face;
determining failure to detect the face of the object from the two-dimensional image in response to that the face identifier determined from the two-dimensional image is inconsistent with the face identifier determined from the preceding image; and
determining that the face of the object is detected from the two-dimensional image in response to that the face identifier determined from the two-dimensional image is consistent with the face identifier determined from the preceding image.

13. The method according to claim 1, wherein, the two-dimensional image, a plurality of first images having consecutive arrangement positions, and a second image all belong to a same video, an arrangement position of the second image in the video is prior to that of each of the first images in the video, the arrangement position of each of the first images in the video is prior to that of the two-dimensional image in the video, with failure to detect the face of the object from each of the first images, a head rotation corresponding to each of the first images reuses a head rotation predicted from the second image; and
the method further comprises:
performing, in response to detecting the face of the object from the two-dimensional image, interpolation processing according to the head rotation predicted from the second image and a head rotation predicted from the two-dimensional image, to obtain an interpolation processing result, wherein the interpolation processing result comprises a plurality of head rotations arranged in sequence, each of the plurality of head rotations being between the head rotation predicted from the second image and the head rotation predicted from the two-dimensional image; and
determining a head rotation corresponding to the two-dimensional image and a head rotation corresponding to at least one third image respectively according to the interpolation processing result, and determining the head rotation predicted from the two-dimensional image as a head rotation corresponding to a fourth image, wherein the arrangement position of the two-dimensional image in the video is prior to that of each of the third image in the video, and the arrangement position of each of the third image in the video is prior to that of the fourth image in the video,
wherein for any of the images in the video, motion capture data corresponding to the image is determined according to a head rotation corresponding to the image.

14. The method according to claim 1, wherein, the first part is an upper body and the second part is the whole body.

15. An electronic device, comprising: a processor and a memory,
wherein the memory is configured to store instructions or a computer program; and
the processor is configured to execute the instructions or computer program in the memory to cause the electronic device to perform a data processing method, comprising:
acquiring a two-dimensional image, which is configured for describing a posture of a first part of an object in a two-dimensional space, and acquiring position information of the object in the two-dimensional image;
cropping a region indicated by the position information from the two-dimensional image to obtain a region image, and predicting skeleton information according to the region image, wherein the skeleton information is configured for describing a posture of a second part of the object in a three-dimensional space, an area of the second part being greater than that of the first part, the second part comprising the first part, and the skeleton information comprises a planar position and a depth, the planar position being located within the region indicated by the position information;
mapping the planar position to a target region by using an objective function to obtain a mapped position, wherein the objective function is configured for describing a position correspondence between the target region and the region indicated by the position information, the target region is obtained by expanding the region indicated by the position information according to an expansion coefficient, and the objective function is determined according to the expansion coefficient; and
determining motion capture data corresponding to the two-dimensional image according to the mapped position and the depth.

16. The electronic device according to claim 15, wherein, the skeleton information is obtained by processing the region image by a skeleton detection model; and
the data processing method further comprises:
determining label information corresponding to the two-dimensional image according to a body part of the object located within the target region, wherein the label information is configured for describing an actual posture of the body part in the three-dimensional space, the body part is part or all of the second part, an area of the body part is greater than that of the first part, and the body part comprises the first part; and
updating the skeleton detection model according to a difference between the motion capture data and the label information.

17. The electronic device according to claim 16, wherein, the motion capture data is configured for describing a predicted posture of the second part under a target skeleton; and
acquiring the label information comprises:
acquiring a three-dimensional mesh corresponding to the two-dimensional image, wherein the three-dimensional mesh is configured for describing an actual posture of a whole body of the object in the three-dimensional space; and
determining the label information according to skeleton information of the three-dimensional mesh under the target skeleton and the body part of the object located within the target region, wherein the label information is configured for indicating an actual posture of the body part under the target skeleton.

18. The electronic device according to claim 15, wherein, after the predicting the skeleton information according to the region image, the data processing method further comprises:
updating, in response to that the skeleton information represents that the first part does not fall completely within the region indicated by the position information, the position information according to a relative position relationship between a part in the first part that falls outside the region indicated by the position information and a part in the first part that falls within the region indicated by the position information, so that a part in the first part that falls within the region indicated by the position information after the updating is more than a part in the first part that falls within the region indicated by the position information before the updating, and continuing performing the step of predicting the skeleton information according to the region image.

19. The electronic device according to claim 18, wherein the data processing method further comprises:
analyzing the relative position relationship from a reference image corresponding to the two-dimensional image, wherein the two-dimensional image and the reference image belong to a same video, an arrangement position of the reference image in the video is prior to that of the two-dimensional image in the video, and the reference image comprises the first part.

20. A non-transitory computer-readable medium, having therein stored instructions or a computer program which, when run on a device, causes the device to perform a data processing method, comprising:
acquiring a two-dimensional image, which is configured for describing a posture of a first part of an object in a two-dimensional space, and acquiring position information of the object in the two-dimensional image;
cropping a region indicated by the position information from the two-dimensional image to obtain a region image, and predicting skeleton information according to the region image, wherein the skeleton information is configured for describing a posture of a second part of the object in a three-dimensional space, an area of the second part being greater than that of the first part, the second part comprising the first part, and the skeleton information comprises a planar position and a depth, the planar position being located within the region indicated by the position information;
mapping the planar position to a target region by using an objective function to obtain a mapped position, wherein the objective function is configured for describing a position correspondence between the target region and the region indicated by the position information, the target region is obtained by expanding the region indicated by the position information according to an expansion coefficient, and the objective function is determined according to the expansion coefficient; and
determining motion capture data corresponding to the two-dimensional image according to the mapped position and the depth.
